(19) United States
(12) Patent Application Publication
(10) Pub. No.: US 2025/0358056 A1
(43) Pub. Date: Nov. 20, 2025

(54) TECHNIQUES FOR HYBRID AUTOMATIC REPEAT REQUEST ADAPTATION

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Diana MAAMARI, San Diego, CA (US)

(21) Appl. No.: 18/665,220

(22) Filed: May 15, 2024

(51) Int. Cl. H04L 1/1829; H04L 1/1812; H04W 72/11

(52) U.S. Cl. CPC H04L 1/1854; H04L 1/1812; H04W 72/11

(57) ABSTRACT

Some examples of the techniques described herein may provide approaches for managing cases of dynamic downlink signal adaptation. For instance, one or more rules may be utilized for semi-persistent scheduling (SPS) hybrid automatic repeat request (HARQ) deferral under dynamic synchronization signal block (SSB) adaptation. In some examples, a UE may determine whether a HARQ message will be deferred due to the SSB before the SSB transmission. With dynamic adaptation, various scenarios may occur. In an example, an existing SSB may be adapted by removal. Accordingly, the SPS HARQ may not collide with the SSB after adaptation, making the previously scheduled uplink resource available for transmission. In another example, the SSB adaptation may add an SSB that collides with SPS HARQ. The UE may defer transmission of the SPS HARQ in this case. For instance, an SPS HARQ message may be deferred under dynamic SSB adaptation to avoid collisions.

### FIELD OF DISCLOSURE

The following relates to wireless communications, including techniques for hybrid automatic repeat request adaptation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, an indication of a configuration of hybrid automatic repeat request (HARQ) deferral for semi-persistent scheduling (SPS), receiving, from the network entity, a first downlink signal in accordance with the SPS, where a first schedule of a HARQ message associated with the first downlink signal is based on the configuration of HARQ deferral and a second schedule of a second downlink signal, receiving, from the network entity, a message for changing the second schedule of the second downlink signal, performing a reevaluation of the first schedule based on the message for changing the second schedule, and transmitting, to the network entity, the HARQ message based on the reevaluation of the first schedule.

A UE for wireless communications is described. The UE may include one or more memories storing processor executable code, and one or more processors coupled with the one or more memories. The one or more processors may individually or collectively be operable to execute the code to cause the UE to receive, from a network entity, an indication of a configuration of HARQ deferral for SPS, receive, from the network entity, a first downlink signal in accordance with the SPS, where a first schedule of a HARQ message associated with the first downlink signal is based on the configuration of HARQ deferral and a second schedule of a second downlink signal, receive, from the network entity, a message for changing the second schedule of the second downlink signal, perform a reevaluation of the first schedule based on the message for changing the second schedule, and transmit, to the network entity, the HARQ message based on the reevaluation of the first schedule.

Another UE for wireless communications is described. The UE may include means for receiving, from a network entity, an indication of a configuration of HARQ deferral for SPS, means for receiving, from the network entity, a first downlink signal in accordance with the SPS, where a first schedule of a HARQ message associated with the first downlink signal is based on the configuration of HARQ deferral and a second schedule of a second downlink signal, means for receiving, from the network entity, a message for changing the second schedule of the second downlink signal, means for performing a reevaluation of the first schedule based on the message for changing the second schedule, and means for transmitting, to the network entity, the HARQ message based on the reevaluation of the first schedule.

A non-transitory computer-readable medium storing code for wireless communications is described. The code may include instructions executable by one or more processors to receive, from a network entity, an indication of a configuration of HARQ deferral for SPS, receive, from the network entity, a first downlink signal in accordance with the SPS, where a first schedule of a HARQ message associated with the first downlink signal is based on the configuration of HARQ deferral and a second schedule of a second downlink signal, receive, from the network entity, a message for changing the second schedule of the second downlink signal, perform a reevaluation of the first schedule based on the message for changing the second schedule, and transmit, to the network entity, the HARQ message based on the reevaluation of the first schedule.

In some examples of the method, UEs, and non-transitory computer-readable medium described herein, transmitting the HARQ message may include operations, features, means, or instructions for transmitting, to the network entity, the HARQ message in accordance with the first schedule, where the HARQ message may be deferred based on the second schedule, and the first schedule may be unchanged based on the message for changing the second schedule.

In some examples of the method, UEs, and non-transitory computer-readable medium described herein, transmitting the HARQ message may include operations, features, means, or instructions for transmitting, to the network entity, the HARQ message via a resource previously allocated to the second downlink signal in accordance with the second schedule, where the HARQ message was previously deferred based on the second schedule, and the first schedule may be changed based on the message for changing the second schedule.

In some examples of the method, UEs, and non-transitory computer-readable medium described herein, the HARQ message may be transmitted via the resource based on the message for changing the second schedule being received at least a threshold quantity of symbols before the HARQ message may be transmitted via the resource.

In some examples of the method, UEs, and non-transitory computer-readable medium described herein, transmitting the HARQ message may include operations, features, means, or instructions for transmitting, to the network entity, the HARQ message via a second resource after a first resource allocated to the second downlink signal in accordance with the second schedule, where the HARQ message may be deferred based on the second schedule, and the first schedule may be changed based on the message for changing the second schedule.

In some examples of the method, UEs, and non-transitory computer-readable medium described herein, the HARQ message may be deferred based on the first resource being allocated for a synchronization signal block (SSB), semi-static downlink symbols, or a control resource set (CORESET) for a type 0 physical downlink control channel (PDCCH) common search space (CSS).

In some examples of the method, UEs, and non-transitory computer-readable medium described herein, transmitting the HARQ message may include operations, features, means, or instructions for transmitting, to the network entity, the HARQ message via a resource allocated to the second downlink signal in accordance with the second schedule, where the first schedule may be unchanged based on the message for changing the second schedule.

In some examples of the method, UEs, and non-transitory computer-readable medium described herein, the HARQ message may be transmitted via the resource based on the message for changing the second schedule being received less than a threshold quantity of symbols before the HARQ message may be transmitted via the resource.

In some examples of the method, UEs, and non-transitory computer-readable medium described herein, the HARQ message may be transmitted via the resource concurrently with receiving the second downlink signal via the resource.

Some examples of the method, UEs, and non-transitory computer-readable medium described herein may further include operations, features, means, or instructions for receiving a first indication of a threshold period for deferral associated with the configuration of HARQ deferral and receiving a second indication for changing the threshold period for deferral associated with the message for changing the second schedule of the second downlink signal.

Some examples of the method, UEs, and non-transitory computer-readable medium described herein may further include operations, features, means, or instructions for receiving, from the network entity, an indication of a set of configurations for a physical uplink control channel (PUCCH) and switching from a first configuration to a second configuration of the set of configurations in association with the message for changing the second schedule.

A method for wireless communications by a network entity is described. The method may include outputting, to a UE, an indication of a configuration of HARQ deferral for SPS, outputting, to the UE, a first downlink signal in accordance with the SPS, where a first schedule of a HARQ message associated with the first downlink signal is based on the configuration of HARQ deferral and a second schedule of a second downlink signal, outputting, to the UE, a message for changing the second schedule of the second downlink signal, performing a reevaluation of the first schedule based on changing the second schedule, and obtaining, from the UE, the HARQ message based on the reevaluation of the first schedule.

A network entity for wireless communications is described. The network entity may include one or more memories storing processor executable code, and one or more processors coupled with the one or more memories. The one or more processors may individually or collectively be operable to execute the code to cause the network entity to output, to a UE, an indication of a configuration of HARQ deferral for SPS, output, to the UE, a first downlink signal in accordance with the SPS, where a first schedule of a HARQ message associated with the first downlink signal is based on the configuration of HARQ deferral and a second schedule of a second downlink signal, output, to the UE, a message for changing the second schedule of the second downlink signal, perform a reevaluation of the first schedule based on changing the second schedule, and obtain, from the UE, the HARQ message based on the reevaluation of the first schedule.

Another network entity for wireless communications is described. The network entity may include means for outputting, to a UE, an indication of a configuration of HARQ deferral for SPS, means for outputting, to the UE, a first downlink signal in accordance with the SPS, where a first schedule of a HARQ message associated with the first downlink signal is based on the configuration of HARQ deferral and a second schedule of a second downlink signal, means for outputting, to the UE, a message for changing the second schedule of the second downlink signal, means for performing a reevaluation of the first schedule based on changing the second schedule, and means for obtaining, from the UE, the HARQ message based on the reevaluation of the first schedule.

A non-transitory computer-readable medium storing code for wireless communications is described. The code may include instructions executable by one or more processors to output, to a UE, an indication of a configuration of HARQ deferral for SPS, output, to the UE, a first downlink signal in accordance with the SPS, where a first schedule of a HARQ message associated with the first downlink signal is based on the configuration of HARQ deferral and a second schedule of a second downlink signal, output, to the UE, a message for changing the second schedule of the second downlink signal, perform a reevaluation of the first schedule based on changing the second schedule, and obtain, from the UE, the HARQ message based on the reevaluation of the first schedule.

In some examples of the method, network entities, and non-transitory computer-readable medium described herein, obtaining the HARQ message may include operations, features, means, or instructions for obtaining, from the UE, the HARQ message in accordance with the first schedule, where the HARQ message may be deferred based on the second schedule, and the first schedule may be unchanged based on the message for changing the second schedule.

In some examples of the method, network entities, and non-transitory computer-readable medium described herein, obtaining the HARQ message may include operations, features, means, or instructions for obtaining, from the UE, the HARQ message via a resource previously allocated to the second downlink signal in accordance with the second schedule, where the HARQ message was previously deferred based on the second schedule, and the first schedule may be changed based on the message for changing the second schedule.

In some examples of the method, network entities, and non-transitory computer-readable medium described herein, the HARQ message may be transmitted via the resource based on the message for changing the second schedule being received at least a threshold quantity of symbols before the HARQ message may be transmitted via the resource.

In some examples of the method, network entities, and non-transitory computer-readable medium described herein, obtaining the HARQ message may include operations, features, means, or instructions for obtaining, from the UE, the HARQ message via a second resource after a first resource allocated to the second downlink signal in accordance with the second schedule, where the HARQ message may be deferred based on the second schedule, and the first schedule may be changed based on the message for changing the second schedule.

In some examples of the method, network entities, and non-transitory computer-readable medium described herein, obtaining the HARQ message may include operations, features, means, or instructions for obtaining, from the UE, the HARQ message via a resource allocated to the second downlink signal in accordance with the second schedule, where the first schedule may be unchanged based on the message for changing the second schedule.

Some examples of the method, network entities, and non-transitory computer-readable medium described herein may further include operations, features, means, or instructions for outputting a first indication of a threshold period for deferral associated with the configuration of HARQ deferral and outputting a second indication for changing the threshold period for deferral associated with the message for changing the second schedule of the second downlink signal.

Some examples of the method, network entities, and non-transitory computer-readable medium described herein may further include operations, features, means, or instructions for outputting, to the UE, an indication of a set of configurations for a PUCCH and switching, from a first configuration to a second configuration of the set of configurations in association with the message for changing the second schedule.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for hybrid automatic repeat request (HARQ) adaptation in accordance with one or more aspects of the present disclosure.

FIG. 2 shows an example of a network architecture that supports techniques for HARQ adaptation in accordance with one or more aspects of the present disclosure.

FIG. 3 shows an example of a wireless communications system that supports techniques for HARQ adaptation in accordance with one or more aspects of the present disclosure.

FIG. 4 shows an example of a timing diagram that supports techniques for HARQ adaptation in accordance with one or more aspects of the present disclosure.

FIG. 5 shows an example of a timing diagram that supports techniques for HARQ adaptation in accordance with one or more aspects of the present disclosure.

FIG. 6 shows an example of a process flow that supports techniques for HARQ adaptation in accordance with one or more aspects of the present disclosure.

FIG. 7 shows a block diagram of a device that supports techniques for HARQ adaptation in accordance with one or more aspects of the present disclosure.

FIG. 8 shows a block diagram of a device that support techniques for HARQ adaptation in accordance with one or more aspects of the present disclosure.

FIG. 9 shows a block diagram of a communications manager that supports techniques for HARQ adaptation in accordance with one or more aspects of the present disclosure.

FIG. 10 shows a diagram of a system including a device that supports techniques for HARQ adaptation in accordance with one or more aspects of the present disclosure.

FIG. 11 shows a block diagram of a device that supports techniques for HARQ adaptation in accordance with one or more aspects of the present disclosure.

FIG. 12 shows a block diagram of a device that supports techniques for HARQ adaptation in accordance with one or more aspects of the present disclosure.

FIG. 13 shows a block diagram of a communications manager that supports techniques for HARQ adaptation in accordance with one or more aspects of the present disclosure.

FIG. 14 shows a diagram of a system including a device that supports techniques for HARQ adaptation in accordance with one or more aspects of the present disclosure.

FIG. 15 shows a flowchart illustrating a method that supports techniques for HARQ adaptation in accordance with one or more aspects of the present disclosure.

FIG. 16 shows a flowchart illustrating a method that supports techniques for HARQ adaptation in accordance with one or more aspects of the present disclosure.

FIG. 17 shows a flowchart illustrating a method that supports techniques for HARQ adaptation in accordance with one or more aspects of the present disclosure.

FIG. 18 shows a flowchart illustrating a method that support techniques for HARQ adaptation in accordance with one or more aspects of the present disclosure.

### DETAILED DESCRIPTION

In some wireless communications systems, energy consumption is a concern. In 3GPP New Radio (NR), for example, network energy saving (NES) may attempt to save network energy in network entity transmission and reception. To save energy, the network entity may reduce some downlink signaling, such as the signaling of synchronization signal blocks (SSBs). For instance, SSB signaling may be adapted in the time domain (e.g., periodicity adaptation). Dynamic adaptation of SSB transmission may be performed in the time domain for NES. While some approaches may adapt SSB transmission in the time domain via a system information block 1 (SIB1) indication, more frequent adaptation (e.g., dynamic adaptation) may be utilized to increase energy efficiency and reduce the impact on legacy user equipment (UE) performance and UE latency. In some cases, dynamic adaptation may cause collisions between dynamically scheduled downlink signals and hybrid automatic repeat request (HARQ) messages scheduled using semi-persistent scheduling (SPS). SPS HARQ may be deferred due to the collision, for example, between SPS HARQ and an SSB, semi-static downlink symbols, or a control resource set (CORESET) for a type 0 physical downlink control channel (PDCCH) common search space (CSS).

Some examples of the techniques described herein may provide approaches for managing cases of dynamic downlink signal adaptation. For instance, one or more rules may be utilized for SPS HARQ deferral under dynamic SSB adaptation. In some examples, a UE may determine whether a HARQ message will be deferred due to the SSB before the SSB transmission. With dynamic adaptation, various scenarios may occur. In an example, an existing SSB may be adapted by removal. Accordingly, the SPS HARQ may not collide with the SSB after adaptation, making the previously scheduled uplink resource available for transmission (unless the SSB removal occurs too closely in time relative to the previously scheduled transmission). In another example, the SSB adaptation may add an SSB that collides with SPS HARQ. The UE may defer transmission of the SPS HARQ in this case. For instance, an SPS HARQ message may be deferred under dynamic SSB adaptation to avoid collisions.

Some examples of the techniques described herein may enhance communication flexibility for SSB adaptation. For instance, as SSBs are adapted to allow for improved NES, communication performance of the UE or network entity may be improved by reducing collisions or reducing SPS HARQ latency. In some examples, SPS HARQ latency may be reduced, which may improve communication (e.g., retransmission) performance.

Aspects of the disclosure are initially described in the context of wireless communications systems. Aspects of the disclosure are also described in the context of timing diagrams and a process flow diagram. Aspects of the disclosure are further illustrated by and described with reference to apparatus diagrams, system diagrams, and flowcharts that relate to techniques for HARQ adaptation.

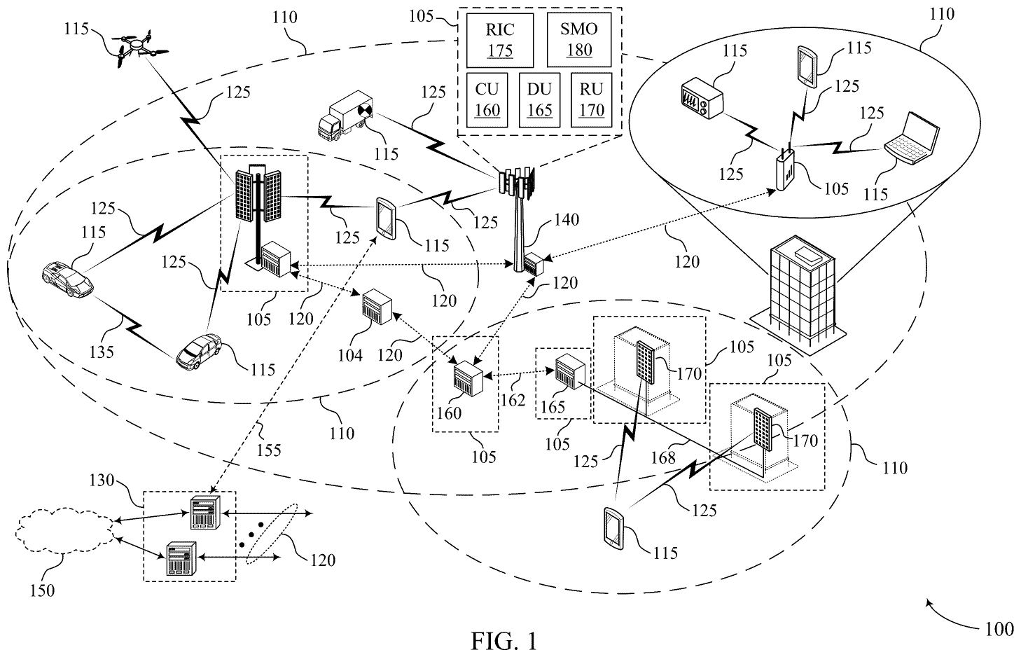

FIG. 1 shows an example of a wireless communications system 100 that supports techniques for HARQ adaptation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a NES network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz may be known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), an unlicensed radio frequency spectrum band RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, energy consumption is a concern. For example, NES may attempt to save network energy in network entity transmission and reception. To save energy, the network entity may reduce some downlink signaling, such as the signaling of SSBs. For instance, SSB signaling may be adapted in the time domain (e.g., periodicity adaptation). Dynamic adaptation of SSB transmission may be performed in the time domain for NES. While some approaches may adapt SSB transmission in the time domain via a SIB1 indication, more frequent adaptation (e.g., dynamic adaptation) may be utilized to increase energy efficiency and reduce the impact on legacy UE performance and UE latency. In some cases, dynamic adaptation may cause collisions between dynamically scheduled downlink signals and HARQ messages scheduled using SPS. In Release 16 specifications, for instance, up to eight SPS configurations per bandwidth part (BWP) for a UE may be utilized with a period down to one slot, which may cause relatively frequent SPS physical uplink control channel (PUCCH) (e.g., SPS HARQ) collisions with downlink transmissions. For example, this feature may allow the transmission of a given SPS HARQ in a PUCCH resource in a later slot that may collide with a downlink transmission. The SPS HARQ may be deferred due to a collision, for example, between SPS HARQ and an SSB, semi-static downlink symbols, or a CORESET for a type 0 PDCCH CSS.

In some examples, a UE 115 and a network entity 105 may communicate in frequency range 2 (FR2) (e.g., in a range of 24.25 through 52.6 gigahertz (GHz)) using a TDD or slot configuration. For instance, the network entity 105 may transmit configuration information to the UE 115. SPS HARQ deferral may be configured per SPS. For example, the configuration information may indicate a maximum deferral time, which may be a maximum time after which the UE 115 stops attempting to find an available PUCCH resource for SPS HARQ that collides with a downlink transmission. The maximum deferral time may be a part of the SPS HARQ deferral configuration and may have a value range of 0 to 31 slots or sub-slots. Layer 1 (L1) priority may also be supported. Two parallel SPS HARQ deferral procedures may be available for a case where the UE 115 is configured with both a high priority (HP) and a low priority (LP) SPS for deferral if both collide: one procedure for HP SPS and another procedure for LP SPS HARQ.

An example of a downlink symbol HARQ collision and SPS HARQ deferral is given as follows. In this example, the UE 115 and the network entity 105 may communicate using an uplink/downlink slot format 42 with an SPS configuration of a period of one millisecond (ms) that includes eight slots (e.g., slot #0 through slot #7). Each slot may occupy 125 microseconds (μs) and may carry 14 symbols. SPS PUCCH acknowledgment (ACK) or negative acknowledgment (NACK) may also be configured.

In a slot #0, the network entity 105 may transmit a physical downlink shared channel (PDSCH), and the UE 115 may transmit an acknowledgment (ACK) that is associated with the PDSCH in a slot #1, 20 symbols after the PDSCH. At the end of the SPS period, a slot format change to downlink/uplink slot format 33 may occur based on an RRC configuration at slot #0. For instance, a slot format change may occur and a slot or sub-slot may have scheduled SPS HARQ. The network entity 105 may transmit a PDSCH in the next slot #0 after the slot format change. An ACK scheduled for the following slot #1 may collide with a downlink transmission in slot #1 due to the slot format change. A slot in which a collision with a downlink transmission occurs may be referred to as an “initial slot.” Deferral triggering may occur in the “initial slot,” where the SPS HARQ is deferred to a slot with a next available PUCCH resource. The slot in which the deferred SPS HARQ is transmitted may be referred to as a “target slot.” SPS HARQ deferral may be triggered when SPS HARQ collides with a semi-static downlink transmission (e.g., symbol(s)), an SSB, or a CORESET for a type 0 PDCCH CSS. In this example, the UE 115 may perform SPS HARQ deferral to a next available PUCCH resource at the end of slot #1.

In some examples, SPS HARQ deferral may not be triggered when a collision occurs with flexible symbols (e.g., the flexible symbols may be converted to downlink symbols). For example, the SPS PUCCH may collide with converted downlink symbols in this case, and the SPS PUCCH may not be transmitted, though deferral may not be triggered. SPS HARQ deferral may not be triggered when another PUCCH or PUSCH occurs in the same slot in which canceled SPS HARQ may be multiplexed. For instance, SPS HARQ may be multiplexed with another PUCCH or a PUSCH on the same slot. Regarding target slot behavior, multiple deferred SPS HARQ codebooks may be multiplexed onto the same target slot. In some examples, a deferred SPS HARQ codebook may be multiplexed with a dynamic grant HARQ codebook or another SPS HARQ codebook at the target slot if the PUCCH resource in the slot is sufficient for the total uplink control information (UCI) payload (e.g., for the HARQ codebooks). When multiplexing a HARQ codebook (e.g., a new HARQ codebook) and a deferred SPS HARQ codebook, the HARQ codebook may be placed first, and the deferred SPS HARQ codebook may be appended to the HARQ codebook. For example, the dynamic grant HARQ may correspond to previous downlink control information (DCI) or a dynamic grant physical downlink shared channel (PDSCH), and the SPS HARQ may be deferred from the initial slot to the target slot.

Some examples of the techniques described herein may provide approaches for managing cases of dynamic downlink signal adaptation. For instance, one or more rules may be utilized for SPS HARQ deferral under dynamic SSB adaptation. In some examples, a UE 115 may determine whether a HARQ message will be deferred due to the SSB before the SSB transmission. With dynamic adaptation, various scenarios may occur. In an example, an existing SSB may be adapted by removal. Accordingly, the SPS HARQ may not collide with the SSB after adaptation, making the previously scheduled uplink resource available for transmission (unless the SSB removal occurs too closely in time relative to the previously scheduled transmission). In another example, the SSB adaptation may add an SSB that collides with SPS HARQ. The UE 115 may defer transmission of the SPS HARQ in this case. For instance, an SPS HARQ message may be deferred under dynamic SSB adaptation to avoid collisions.

Some examples of the techniques described herein relate to the impact of an SSB that is dynamically added or removed (e.g., dynamic SSB adaptation) on the deferral of SPS HARQ-ACK. NES may be improved via SSB adaptation in the time domain, which may be applicable in a variety of situations. For instance, SSB adaptation may be applied in a primary cell (PCell) or in a secondary cell (SCell), for one or more connected UEs 115 or one or more UEs 115 in an idle or inactive state. In some examples, a UE 115 may switch between cells of a PUCCH transmission if the cells are in a same PUCCH cell group. Accordingly, HARQ deferral may occur in an SCell.

In some examples, SPS HARQ-ACK deferral may be applicable for ultra reliable and low latency communications (URLLC) or a variety of other services in 5G NR. For instance, dynamic SSB adaptation may be utilized in the context of URLLC, where a deferral is reversed if an SSB is removed, which may reduce the latency of the HARQ-ACK.

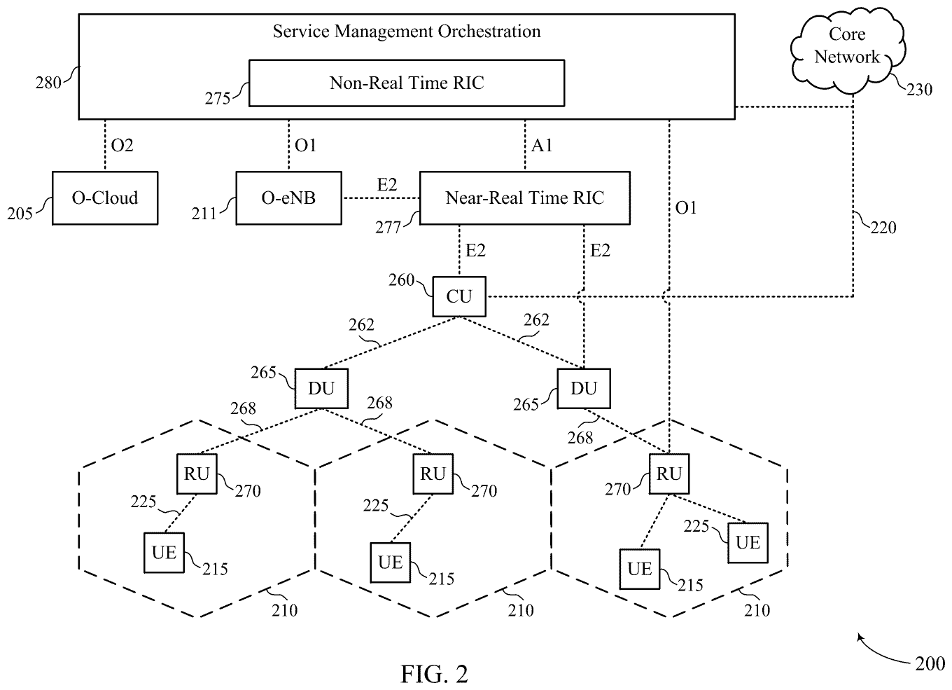

FIG. 2 shows an example of a network architecture 200 that supports techniques for HARQ adaptation in accordance with one or more aspects of the present disclosure. The network architecture 200 (e.g., a disaggregated base station architecture, a disaggregated RAN architecture) may illustrate an example for implementing one or more aspects of the wireless communications system 100. The network architecture 200 may include one or more CUs 260 that may communicate directly with a core network 230 via a backhaul communication link 220, or indirectly with the core network 230 through one or more disaggregated network entities (e.g., a Near-RT RIC 277 via an E2 link, or a Non-RT RIC 275 associated with an SMO 280 (e.g., an SMO Framework), or both). A CU 260 may communicate with one or more DUs 265 via respective midhaul communication links 262 (e.g., an F1 interface). The DUs 265 may communicate with one or more RUs 270 via respective fronthaul communication links 268. The RUs 270 may be associated with respective coverage areas 210 and may communicate with UEs 215 via one or more communication links 225. In some implementations, a UE 215 may be simultaneously served by multiple RUs 270.

The one or more CUs 260 may be examples of the CU 160 (as shown in FIG. 1). The core network 230 may be an example of the core network 130 (as shown in FIG. 1). The backhaul communication link 220 may be an example of the backhaul communication link 120 (as shown in FIG. 1). The Near-RT RIC 277 or the Non-RT RIC 275 may be examples of the RIC 175 (as shown in FIG. 1). The SMO 280 may be an example of the SMO system 180 (as shown in FIG. 1). The one or more DUs 265 may be examples of the DU 165 (as shown in FIG. 1). The midhaul communication links 262 may be examples of the midhaul communication link 162 (as shown in FIG. 1). The fronthaul communication link 268 may be an example of the fronthaul communication link 168 (as shown in FIG. 1). The RUs 270 may be examples of the RU 170 (as shown in FIG. 1). The coverage areas 210 may be examples of the coverage area 110 (as shown in FIG. 1). The one or more UEs 215 may be examples of the one or more UEs 115 (as shown in FIG. 1).

Each of the network entities 105 of the network architecture 200 (e.g., CUs 260, DUs 265, RUs 270, Non-RT RICs 275, Near-RT RICs 277, SMOs 280, Open Clouds (O-Clouds) 205, Open eNBs (O-eNBs) 211) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 260 may host one or more higher layer control functions. Such control functions may include RRC, PDCP, SDAP, or the like. Each control function may be implemented with an interface configured to communicate signals with other control functions hosted by the CU 260. A CU 260 may be configured to handle user plane functionality (e.g., CU-UP), control plane functionality (e.g., CU-CP), or a combination thereof. In some examples, a CU 260 may be logically split into one or more CU-UP units and one or more CU-CP units. A CU-UP unit may communicate bidirectionally with the CU-CP unit via an interface, such as an E1 interface when implemented in an O-RAN configuration. A CU 260 may be implemented to communicate with a DU 265, as necessary, for network control and signaling.

A DU 265 may correspond to a logical unit that includes one or more functions (e.g., base station functions, RAN functions) to control the operation of one or more RUs 270. In some examples, a DU 265 may host, at least partially, one or more of an RLC layer, a MAC layer, and one or more aspects of a PHY layer (e.g., a high PHY layer, such as components for FEC encoding and decoding, scrambling, modulation and demodulation, or the like) depending, at least in part, on a functional split, such as those defined by the 3rd Generation Partnership Project (3GPP). In some examples, a DU 265 may further host one or more low PHY layers. Each layer may be implemented with an interface configured to communicate signals with other layers hosted by the DU 265, or with control functions hosted by a CU 260.

In some examples, lower-layer functionality may be implemented by one or more RUs 270. For example, an RU 270, controlled by a DU 265, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 270 may be implemented to handle over the air (OTA) communication with one or more UEs 215. In some implementations, real-time and non-real-time aspects of control and user plane communication with the RU(s) 270 may be controlled by the corresponding DU 265. In some examples, such a configuration may enable a DU 265 and a CU 260 to be implemented in a cloud-based RAN architecture, such as a vRAN architecture.

The SMO 280 may be configured to support RAN deployment and provisioning of non-virtualized and virtualized network entities, which may be examples of the network entity 105 (as shown in FIG. 1). For non-virtualized network entities, the SMO 280 may be configured to support the deployment of dedicated physical resources for RAN coverage requirements which may be managed via an operations and maintenance interface (e.g., an O1 interface). For virtualized network entities, the SMO 280 may be configured to interact with a cloud computing platform (e.g., an O-Cloud 205) to perform network entity life cycle management (e.g., to instantiate virtualized network entities) via a cloud computing platform interface (e.g., an O2 interface). Such virtualized network entities can include, but are not limited to, CUs 260, DUs 265, RUs 270, and Near-RT RICs 277. In some implementations, the SMO 280 may communicate with components configured in accordance with a 4G RAN (e.g., via an O1 interface). Additionally, or alternatively, in some implementations, the SMO 280 may communicate directly with one or more RUs 270 via an O1 interface. The SMO 280 also may include a Non-RT RIC 275 configured to support functionality of the SMO 280.

The Non-RT RIC 275 may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 277. The Non-RT RIC 275 may be coupled to or communicate with (e.g., via an A1 interface) the Near-RT RIC 277. The Near-RT RIC 277 may be configured to include a logical function that enables near-real-time control and optimization of RAN elements and resources via data collection and actions over an interface (e.g., via an E2 interface) connecting one or more CUs 260, one or more DUs 265, or both, as well as an O-eNB 211, with the Near-RT RIC 277.

In some examples, to generate AI/ML models to be deployed in the Near-RT RIC 277, the Non-RT RIC 275 may receive parameters or external enrichment information from external servers. Such information may be utilized by the Near-RT RIC 277 and may be received at the SMO 280 or the Non-RT RIC 275 from non-network data sources or from network functions. In some examples, the Non-RT RIC 275 or the Near-RT RIC 277 may be configured to tune RAN behavior or performance. For example, the Non-RT RIC 275 may monitor long-term trends and patterns for performance and employ AI or ML models to perform corrective actions through the SMO 280 (e.g., reconfiguration via O1) or via generation of RAN management policies (e.g., A1 policies).

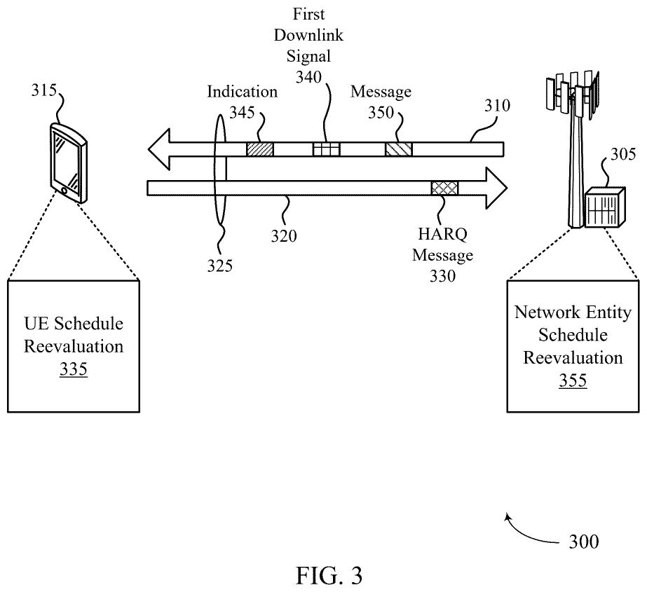

Some examples of the techniques described herein may be performed utilizing the network architecture 200. For instance, a UE 215 may receive, from an RU 270, a DU 265, or a CU 260, an indication of a configuration of HARQ deferral for SPS. The UE 215 may receive, from the RU 270, the DU 265, or the CU 260, a first downlink signal in accordance with the SPS, where a first schedule of a HARQ message associated with the first downlink signal is based on the configuration of the HARQ deferral and a second schedule of a second downlink signal (e.g., SSB). The UE 215 may receive, from the RU 270, DU 265, or CU 260, a message for changing the second schedule of the second downlink signal. The UE 215 may reevaluate the first schedule of the HARQ message based on the message for changing the second schedule of the second downlink signal. The UE 215 may transmit, to the RU 270, DU 265, or CU 260, the HARQ message based on the reevaluation. In some examples, the UE 215 or one or more of the RU 270, DU 265, or CU 260 may perform one or more of the operations described with reference to FIG. 1 or any of FIGS. 3 through 18.

FIG. 3 shows an example of a wireless communications system 300 that supports techniques for HARQ adaptation in accordance with one or more aspects of the present disclosure. The wireless communications system 300 may implement aspects of or may be implemented by aspects of the wireless communications system 100 (as shown in FIG. 1) or the network architecture 200 (as shown in FIG. 2). For example, the wireless communications system 300 includes a UE 315, which may be an example of a UE 115 (as shown in FIG. 1) or the UE 215 (as shown in FIG. 2). The wireless communications system 300 also includes a network entity 305, which may be an example of a network entity 105 (as shown in FIG. 1).

The UE 315 may communicate with the network entity 305 using a communication link 325, which may be an example of a communication link 125 (as shown in FIG. 1) or an example of the communication link 225 (as shown in FIG. 2). The communication link 325 may include a bi-directional link that enables uplink or downlink communications. For example, the UE 315 may transmit one or more uplink transmissions 320, such as uplink control signals or uplink data signals, to the network entity 305 using the communication link 325, or the network entity 305 may transmit one or more downlink transmissions 310, such as downlink control signals or downlink data signals, to the UE 315 using the communication link 325.

The network entity 305 may output (e.g., transmit), or the UE 315 may receive, an indication 345 of a configuration of HARQ deferral for SPS. For example, the indication 345 may be communicated in configuration signaling. As used herein, the term “communicate” and variations thereof may denote output, transmission, obtaining, or reception. The indication 345 may indicate (e.g., instruct, command, or request) that HARQ deferral may be performed for some cases where uplink HARQ (e.g., the HARQ message 330) may collide with downlink signaling (e.g., an SSB). SPS may be a scheduling scheme where recurring resources are scheduled for communication. For instance, signaling (e.g., HARQ on an SPS PUCCH) may be scheduled to occur periodically or in accordance with an uplink/downlink configuration. The UE 315 may generate HARQ (e.g., ACKs or NACKs) for downlink signaling received from the network entity 305. In HARQ deferral for SPS, the HARQ may be deferred (e.g., delayed) to a next available PUCCH resource when a collision (e.g., scheduling collision) occurs between downlink signaling (e.g., an SSB) and the HARQ.

The network entity 305 may output (e.g., transmit), or the UE 315 may receive, a first downlink signal 340 in accordance with the SPS. For example, the first downlink signal 340 may be a control signal or a data signal. The UE 315 may generate a HARQ message 330 indicating whether the first downlink signal 340 was successfully received. A first schedule (e.g., an uplink scheduled time period, slot, or resource, among other examples) of a HARQ message 330 associated with the first downlink signal 340 may be based on the configuration of HARQ deferral and a second schedule (e.g., a downlink scheduled time period, slot, or resource, among other examples) of a second downlink signal (not shown in FIG. 3). For instance, a collision may occur when the second downlink signal (e.g., an SSB) is scheduled to occur in a same period or an overlapping period (e.g., time slot) as the HARQ message 330. As described herein, the UE 315 may defer the HARQ message 330 when a collision is detected. For instance, the HARQ message 330 may be deferred when the HARQ message 330 collides with one or more semi-static downlink symbols, an SSB, or a CORESET for type 0 PDCCH CSS. In a scenario where no collision is detected, the HARQ message 330 may be scheduled without HARQ deferral. In some examples, the first downlink signal 340, the HARQ for the first downlink signal 340, or other signaling may be scheduled via an RRC configuration message.

The network entity 305 may output (e.g., transmit), or the UE 315 may receive, a message 350 for changing the second schedule of the second downlink signal. For example, the message 350 may indicate a removal of the second downlink signal, an addition of the second downlink signal, or a rescheduling of the second downlink signal. In some examples, the message 350 for changing the second schedule may indicate a change in periodicity of the second downlink signal, a change in a position of the second downlink signal in a burst, a dynamic removal of the second downlink signal, or a dynamic addition of the second downlink signal, among other examples. In some aspects, the second downlink signal may be an SSB. The message 350 may be (or may include) a system information block (SIB) (e.g., a SIB1 for adapting an SSB periodicity) via RRC signaling, DCI (e.g., paging DCI), or a media access control control element (MAC CE), among other examples. In some examples, the message 350 may be communicated via a lower layer than other signaling for SSB adaptation. For instance, the message 350 may be communicated via layer 1 (L1) signaling or layer 2 (L2) signaling, while other signaling for changing SSB scheduling may be communicated via a higher layer (e.g., layer 3 (L3) or RRC) signaling. In some examples, the message 350 may be communicated during a modification period. In some examples, the message 350 may be communicated after a determination (e.g., decision) for HARQ message 350 deferral, and before the second downlink signal is communicated or before the deferral is executed.

The network entity 305 may perform a network entity schedule reevaluation 355 of the first schedule based on changing the second schedule. Additionally, or alternatively, the UE 315 may perform a UE schedule reevaluation 335 of the first schedule based on the message 350 for changing the second schedule. Reevaluating the first schedule of the HARQ message 330 may include determining whether to maintain the first schedule of the HARQ message 330 or to change the first schedule of the HARQ message 330 based on the change of the second schedule of the second downlink signal. For example, the reevaluation (e.g., the UE schedule reevaluation 335 or the network entity schedule reevaluation 355) of the first schedule of the HARQ message 330 may maintain scheduling based on a previous deferral determination (e.g., may maintain scheduling for the HARQ message 330, where the HARQ message 330 was deferred or not deferred), may reverse a previous deferral (e.g., may change scheduling of the HARQ message 330 back to a resource scheduled before deferral), or may cancel (e.g., drop) the HARQ message 330. For instance, the UE 315 may refrain from transmitting, or the network entity 305 may refrain from obtaining, the HARQ message 330 based on the reevaluation of the first schedule.

In some examples, the UE 315 may transmit, or the network entity 305 may obtain, the HARQ message 330 based on the reevaluation of the first schedule. In some aspects, the UE 315 may transmit, or the network entity 305 may obtain, the HARQ message 330 in accordance with the first schedule, where the HARQ message 330 (e.g., SPS HARQ) may be deferred based on the second schedule, and the first schedule may be unchanged based on the message 350 for changing the second schedule. For instance, if the HARQ message 330 was deferred due to a collision with the second downlink signal (e.g., SSB), and the second downlink signal is removed from the colliding resource, the HARQ message 330 scheduling may be maintained. In an example, if the UE 315 or the network entity 305 determined to defer SPS HARQ due to a collision with an SSB, and then the message 350 (e.g., a dynamic adaptation of the SSB) is communicated that indicates removal of the SSB, the deferred SPS HARQ may not be impacted after the removal of the SSB. For instance, the network entity 305 or the UE 315 may follow a rule to maintain the scheduling to the HARQ message 330 with the previous deferral when the message 350 indicates a removal of the second downlink signal (e.g., a removal of a collision between SPS HARQ and an SSB).

In some examples, the UE 315 may transmit, or the network entity 305 may obtain, the HARQ message 330 via a resource previously allocated to the second downlink signal in accordance with the second schedule, where the HARQ message 330 was previously deferred based on the second schedule, and where the first schedule may be changed based on the message 350 for changing the second schedule. For instance, if the HARQ message 330 was deferred due to a collision with the second downlink signal (e.g., SSB), and the second downlink signal is removed from the colliding resource, the HARQ message 330 may be rescheduled to the resource.

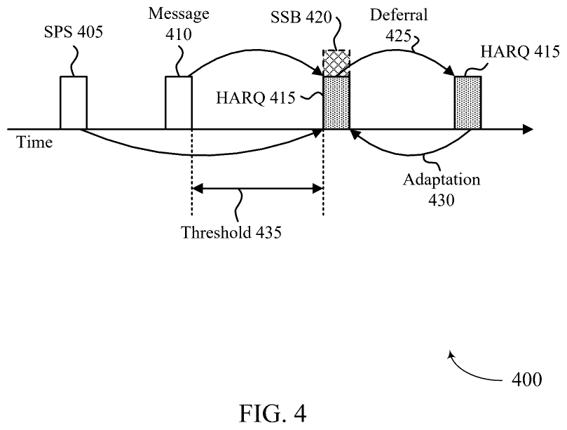

In some aspects, the HARQ message 330 may be communicated via the resource based on the message 350 for changing the second schedule being received at least a threshold quantity of symbols (e.g., N) before the HARQ message 330 is transmitted via the resource. For instance, if the UE 315 or the network entity 305 determined to defer SPS HARQ due to a collision with an SSB, and then the message 350 (e.g., a dynamic adaptation of the SSB) is communicated that removes the SSB, the uplink resources may be available for the SPS HARQ if the dynamic adaptation is received at least N symbols before the uplink resource and there is no other collision with semi-static downlink symbols or CORESET for type 0 PDCCH CSS. In some aspects, N may be based on a subcarrier spacing (SCS) (e.g., may vary based on SCS). An example of reversing a HARQ deferral is given with reference to FIG. 4.

In some examples, the HARQ message 330 may be communicated via a second resource after a first resource allocated to the second downlink signal in accordance with the second schedule, where the HARQ message 330 may be deferred based on the second schedule, and where the first schedule may be changed based on the message 350 for changing the second schedule. For instance, if the HARQ message 330 is initially scheduled at the first resource (e.g., with a determination to not defer the HARQ message 330) and the message 350 indicates that the first resource is allocated to the second downlink signal (e.g., an SSB), the HARQ message 330 may be deferred to the second resource.

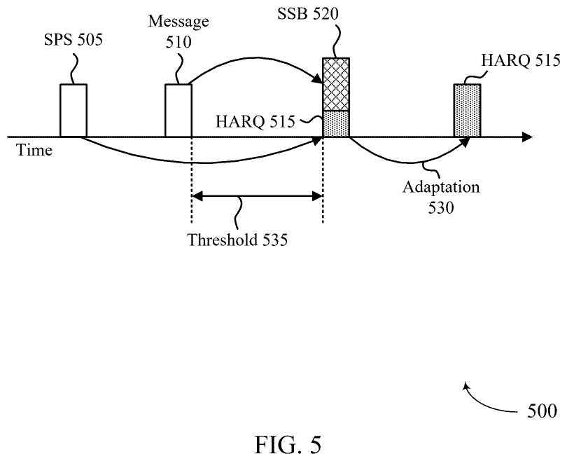

In some aspects, the HARQ message 330 may be deferred based on the first resource being allocated for a SSB, semi-static downlink symbols, or a CORESET for a type 0 PDCCH CSS. In an example, if the UE 315 or the network entity 305 determines to communicate SPS HARQ in some uplink resources, and then the message 350 in communicated indicating a dynamic adaptation that adds an SSB colliding with the uplink resources, the SPS HARQ transmission may be deferred (e.g., delayed) to the nearest uplink resources that do not collide with semi-static downlink symbols, an SSB, or a CORESET for type 0 PDCCH CSS, among other examples. An example of a HARQ deferral (after a determination to not defer, for instance), is given with reference to FIG. 5.

In some examples, the HARQ message 330 may be communicated via a resource allocated to the second downlink signal in accordance with the second schedule, where the first schedule is unchanged based on the message 350 for changing the second schedule. For instance, the UE 315 or the network entity 305 may not defer the HARQ message 330 (e.g., the SPS HARQ transmission) and may refrain from communicating the second downlink signal (e.g., SSB). In some aspects, the HARQ message 330 may be communicated via the resource based on the message 350 for changing the second schedule being received less than a threshold quantity of symbols before the HARQ message 330 is transmitted via the resource. In an example, if the message 350 is communicated with less than the threshold quantity of (e.g., N) symbols before the resource, the second downlink signal (e.g., SSB) may not be communicated in the resource (but may be communicated in a later recurrence of the resource, for instance).

In some examples, the HARQ message 330 may be communicated via the resource concurrently with receiving the second downlink signal via the resource. For instance, the UE 315 or the network entity 305 may not defer the SPS HARQ (e.g., may communicate the SPS HARQ) and may communicate the SSB. In an example, the HARQ message 330 and the second downlink signal may be communicated via a subband full duplex (SBFD) scheme.

In some aspects, the UE 315 may discontinue attempting to determine a first available PUCCH resource for an SPS HARQ that has collided with a downlink signal after a threshold period (e.g., a maximum time that ranges from {0 to 31}), where the threshold period may be indicated in configuration signaling (e.g., SPS HARQ deferral configuration signaling) from the network entity 305. The network entity 305 may determine the threshold period based on the downlink signal(s) (e.g., an SSB) that may cause one or more collisions. For each SSB time domain configuration, for example, the network entity 305 may determine a threshold period (e.g., maximum period) for deferral. Because dynamic adaptation may change potential collisions (e.g., may achieve a point between two or more configurations), the UE 315 or the network entity 305 may adapt the threshold period (e.g., maximum deferral time) for one or more dynamic adaptations.

In some examples, the network entity 305 may output, or the UE 315 may receive, a first indication of a threshold period for deferral associated with the configuration of HARQ deferral. The network entity 305 may output, or the UE 315 may receive, a second indication for changing the threshold period for deferral associated with the message 350 for changing the second schedule of the second downlink signal. In an example, for each SPS configuration with a threshold period (e.g., a maximum configured deferral time), when the UE 315 receives a dynamic adaptation reducing the SSB periodicity, the UE 315 may be configured or dynamically indicated to change the threshold period (e.g., maximum deferral time). For instance, if the SSB periodicity changes from 20 ms to 40 ms, the threshold period (e.g., maximum deferral time) may be reduced by a quantity of (e.g., x) slots. In some examples, the quantity of slots may be configured via RRC signaling. In some examples, the message 350 (e.g., the SSB dynamic adaptation indication) may include a bit that indicates whether the UE 315 is to adapt the threshold period (e.g., maximum deferral time) or not.

In some approaches, deferral based on SSB collisions may be based on a same SSB configuration. With dynamic SSB adaptation, as described herein, performance may be improved by switching PUCCH configurations. In some examples, the network entity 305 may output, or the UE 315 may receive, an indication of a set of configurations for a PUCCH. The UE 315 or the network entity 305 may switch from a first configuration to a second configuration of the set of configurations in association with (e.g., based on) the message 350 for changing the second schedule. In an example, when a set of configurations (e.g., SPS-PUCCH-AN-List) is provided (e.g., RRC configured via a PUCCH-config), the configuration for dynamic adaptation of SSB may be enhanced. For instance, more than one set of configurations (e.g., lists) for a PUCCH may be configured. A set of configurations for a PUCCH may be utilized for each SSB configuration. The UE 315 or the network entity 305 may switch between the sets of configurations for a PUCCH based on the SSB configuration.

FIG. 4 shows an example of a timing diagram 400 that supports techniques for HARQ adaptation in accordance with one or more aspects of the present disclosure. The timing diagram 400 illustrates an SPS 405, a message 410, a HARQ 415, and an SSB 420. The SPS 405 may be an example of the first downlink signal 340 (as shown in FIG. 3). The message 410 may be an example of the message 350 (as shown in FIG. 3). The SSB 420 may be an example of the second downlink signal described herein. The HARQ 415 may be an example of the HARQ message 330 (as shown in FIG. 3).

In this example, the network entity 305 and the UE 315 may communicate an SPS 405 (e.g., a downlink signal in accordance with SPS). Based on the SPS 405, the HARQ 415 may be scheduled to indicate whether the SPS 405 was successfully received or not. However, the SSB 420 may be scheduled concurrently with the HARQ 415, thereby causing a scheduling collision. Due to the scheduling collision, the network entity 305 and the UE 315 may determine (e.g., evaluate) a deferral 425 of the HARQ 415 to a subsequent time (e.g., to the first available PUCCH resources after the initially scheduled resources where the scheduling collision occurred).

Before the resources (e.g., symbols or sub-slot, among other examples) where the scheduling collision occurred, the network entity 305 and the UE 315 may communicate a message 410. The message 410 may indicate a change to the SSB 420 schedule (e.g., a change to SSB 420 periodicity, a change in the location of the SSB 420 in a burst, or cancelation of the SSB 420, among other examples). Due to the change in the SSB 420 schedule, the SSB 420 may be removed from the resources where the scheduling collision occurred.

The UE 315 or the network entity 305 may perform a reevaluation of the schedule for the HARQ 415. The reevaluation may be performed to potentially change the schedule for the HARQ 415 due to the removal of the SSB 420. For instance, if the message 510 is communicated greater than a threshold 435 amount (e.g., greater than a quantity of symbols or amount of time) before the resources (e.g., before the resources where the scheduling collision occurred), the UE 315 or the network entity 305 may perform an adaptation 430. In the example of FIG. 4, the UE 315 and the network entity 305 may perform an adaptation 430 to reverse the deferral 425. For instance, the HARQ 415 may be rescheduled to the initially scheduled resources. Accordingly, HARQ 415 latency may be reduced, which may improve communication (e.g., retransmission) performance. If the message 410 is not received before the threshold 435 amount, the HARQ 415 may not be rescheduled in some examples.

FIG. 5 shows an example of a timing diagram 500 that supports techniques for HARQ adaptation in accordance with one or more aspects of the present disclosure. The timing diagram 500 illustrates an SPS 505, a message 510, a HARQ 515, and an SSB 520. The SPS 505 may be an example of the first downlink signal 340 (as shown in FIG. 3). The message 510 may be an example of the message 350 (as shown in FIG. 3). The SSB 520 may be an example of the second downlink signal described herein. The HARQ 515 may be an example of the HARQ message 330 (as shown in FIG. 3).

In this example, the network entity 305 and the UE 315 may communicate an SPS 505 (e.g., a downlink signal in accordance with SPS). Based on the SPS 505, the HARQ 515 may be scheduled to indicate whether the SPS 505 was successfully received or not. In this example, the HARQ 515 may be initially scheduled in resources without a collision. For instance, the network entity 305 and the UE 315 may perform a deferral determination and may determine not to defer the HARQ 515 due to no scheduling collision.

Before the resources (e.g., symbols or sub-slot, among other examples) where the HARQ 515 is scheduled, the network entity 305 and the UE 315 may communicate a message 510. The message 510 may indicate a change to the SSB 520 schedule (e.g., a change to SSB 520 periodicity, a change in the location of the SSB 520 in a burst, or addition of the SSB 520, among other examples). Due to the change in the SSB 520 schedule, the SSB 520 may be scheduled in the resources where the HARQ 515 is scheduled. For instance, the SSB 520 may be scheduled concurrently with the HARQ 515, thereby causing a scheduling collision.

The UE 315 or the network entity 305 may perform a reevaluation of the schedule for the HARQ 515. The reevaluation may be performed to potentially change the schedule for the HARQ 515 due to the addition of the SSB 520. For instance, if the message 510 is communicated greater than a threshold 535 amount (e.g., greater than a quantity of symbols or amount of time) before the resources (e.g., before the resources where the scheduling collision occurred), the UE 315 or the network entity 305 may perform an adaptation 530. In the example of FIG. 5, the UE 315 and the network entity 305 may perform an adaptation 530 to defer (e.g., delay) the HARQ 515 to a subsequent time (e.g., to the first available PUCCH resources after the initially scheduled resources where the scheduling collision occurred). For instance, the HARQ 515 may be rescheduled after the initially scheduled resources. Accordingly, HARQ 515 flexibility may be enhanced for SSB adaptation, which may improve communication (e.g., retransmission) performance. If the message 510 is not received before the threshold 535 amount, the HARQ 515 may not be rescheduled or the SSB 520 may not be communicated in some examples.

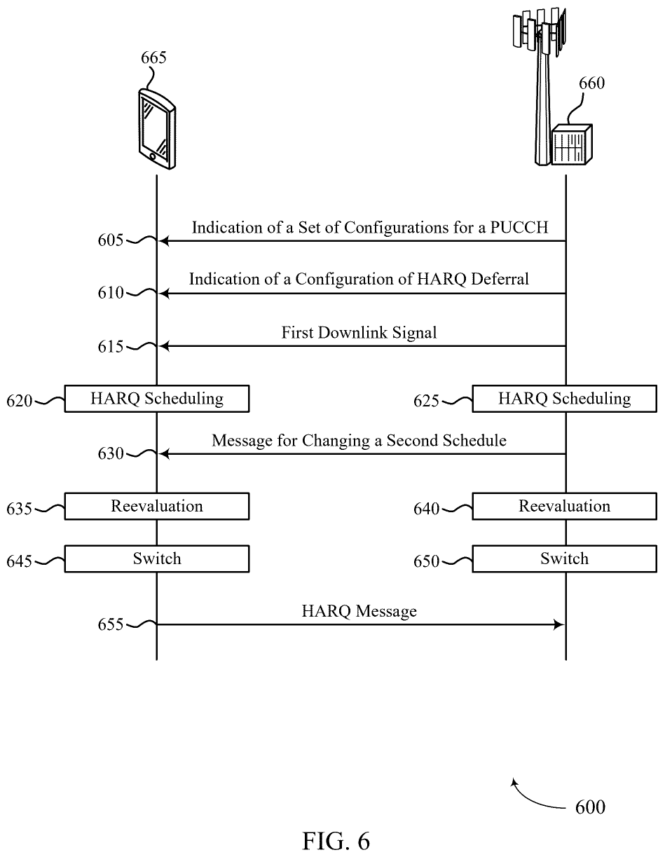

FIG. 6 shows an example of a process flow 600 that supports techniques for HARQ adaptation in accordance with one or more aspects of the present disclosure. A wireless communication system may include a UE 665 and a network entity 660. The UE 665 may be an example of the UEs 115 (as shown in FIG. 1), the UE 215 (as shown in FIG. 2), or the UE 315 (as shown in FIG. 3), and the network entity 660 may be an example of the network entities 105 (as shown in FIG. 1) or the network entity 305 (as shown in FIG. 3).

In the following description of the process flow 600, the operations between the network entity 660 and the UE 665 may be transmitted in a different order than the example order shown, or the operations performed by the network entity 660 and the UE 665 may be performed in different orders or at different times. Some operations may be omitted from the process flow 600, or other operations may be added to the process flow 600. One or more of the operations or signaling may be combined or divided. Although some operations or signaling may be shown to occur at different times for discussion purposes, these operations may actually occur at the same time or in overlapping time periods in some examples.

At 605, the network entity 660 may output, or the UE 665 may receive, an indication of a set of configurations for a PUCCH. For example, the UE 665 may receive the indication of the set of configurations as described with reference to FIG. 3. For instance, the set of configurations may include multiple lists of configurations, where each list of configurations corresponds to an SSB configuration.

At 610, the network entity 660 may output, or the UE 665 may receive, an indication of a configuration of HARQ deferral. For example, the UE 665 may receive an indication of a configuration of HARQ deferral for SPS as described with reference to FIG. 3.

At 615, the network entity 660 may output, or the UE 665 may receive, a first downlink signal. For example, the UE 665 may receive a first downlink signal (e.g., SPS) as described with reference to FIG. 3, FIG. 4, or FIG. 5.

At 620, the UE 665 may perform HARQ scheduling. For example, the UE 665 may determine a first schedule of HARQ associated with the first downlink signal as described with reference to FIG. 3, FIG. 4, or FIG. 5. For instance, the UE 665 may determine whether to defer the HARQ based on a second schedule of a second downlink signal (e.g., SSB).

At 625, the network entity 660 may perform HARQ scheduling. For example, the network entity 660 may determine a first schedule of HARQ associated with the first downlink signal as described with reference to FIG. 3, FIG. 4, or FIG. 5. For instance, the network entity 660 may determine whether to defer the HARQ based on a second schedule of a second downlink signal (e.g., SSB).

At 630, the network entity 660 may output, or the UE 665 may receive, a message for changing a second schedule of a second downlink signal. For example, the UE 665 may receive a message indicating a change to the second schedule of the second downlink signal as described with reference to FIG. 3, FIG. 4, or FIG. 5. For instance, the message may indicate a change in SSB periodicity, a change in a location of the SSB in a burst, removal of an SSB, or addition of an SSB.

At 635, the UE 665 may perform a reevaluation of the first schedule of the HARQ. For instance, the UE 665 may reevaluate the first schedule of the HARQ as described with reference to FIG. 3, FIG. 4, or FIG. 5.

At 640, the UE 665 may perform a reevaluation of the first schedule of the HARQ. For instance, the UE 665 may reevaluate the first schedule of the HARQ as described with reference to FIG. 3, FIG. 4, or FIG. 5.

At 645, the UE 665 may switch from a first configuration to a second configuration of the set of configurations in association with (e.g., based on) the change to the second schedule. For instance, the UE 665 may switch to a different configuration based on the SSB configuration as described with reference to FIG. 3.

At 650, the network entity 660 may switch from a first configuration to a second configuration of the set of configurations in association with (e.g., based on) the change to the second schedule. For instance, the network entity may switch to a different configuration based on the SSB configuration as described with reference to FIG. 3.

At 655, the UE 665 may transmit, or the network entity 660 may obtain, a HARQ message. For instance, the UE 665 may transmit the HARQ message indicating the HARQ based on the reevaluation as described with reference to FIG. 3, FIG. 4, or FIG. 5.

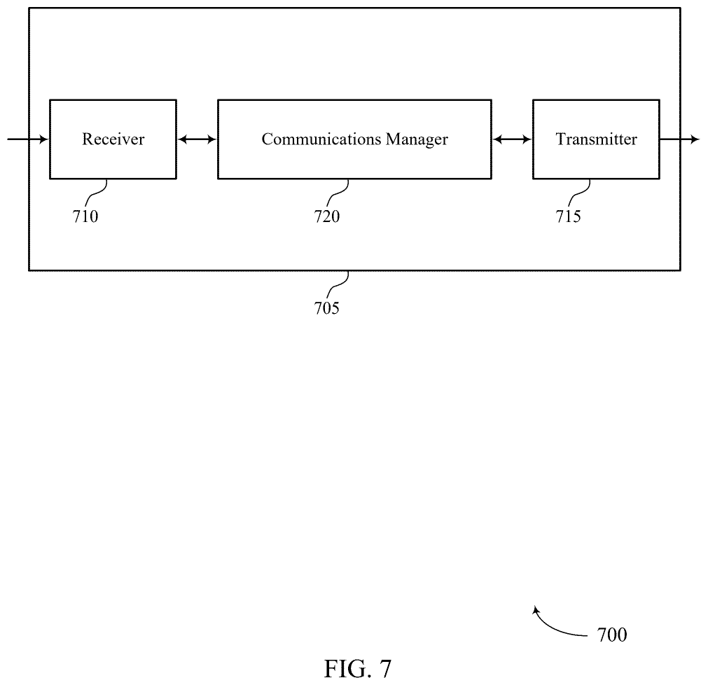

FIG. 7 shows a block diagram 700 of a device 705 that supports techniques for HARQ adaptation in accordance with one or more aspects of the present disclosure. The device 705 may be an example of aspects of a UE 115 (as shown in FIG. 1). The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for HARQ adaptation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for HARQ adaptation). In some examples, the transmitter 715 may be co-located with a receiver 710 in a transceiver component. The transmitter 715 may utilize a single antenna or a set of multiple antennas.

The communications manager 720, the receiver 710, the transmitter 715, or various combinations or components thereof may be examples of means for performing various aspects of techniques for HARQ adaptation as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, from a network entity, an indication of a configuration of HARQ deferral for SPS. The communications manager 720 is capable of, configured to, or operable to support a means for receiving, from the network entity, a first downlink signal in accordance with the SPS, where a first schedule of a HARQ message associated with the first downlink signal is based on the configuration of HARQ deferral and a second schedule of a second downlink signal. The communications manager 720 is capable of, configured to, or operable to support a means for receiving, from the network entity, a message for changing the second schedule of the second downlink signal. The communications manager 720 is capable of, configured to, or operable to support a means for performing a reevaluation of the first schedule based on the message for changing the second schedule. The communications manager 720 is capable of, configured to, or operable to support a means for transmitting, to the network entity, the HARQ message based on the reevaluation of the first schedule.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, or more efficient utilization of communication resources.

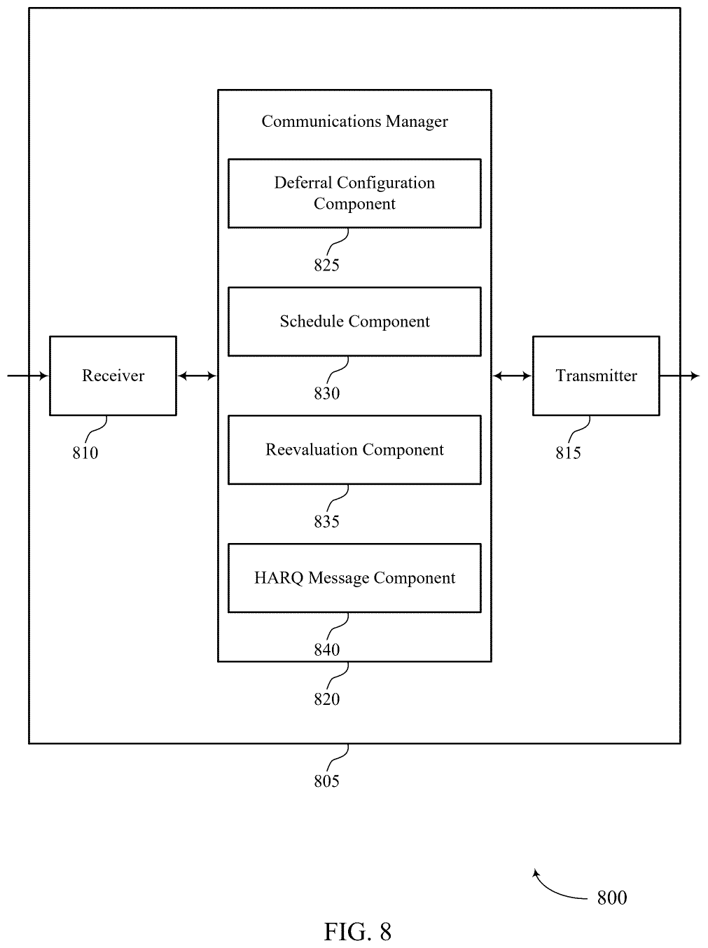

FIG. 8 shows a block diagram 800 of a device 805 that supports techniques for HARQ adaptation in accordance with one or more aspects of the present disclosure. The device 805 may be an example of aspects of a device 705 (as shown in FIG. 7) or a UE 115 (as shown in FIG. 1). The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for HARQ adaptation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for HARQ adaptation). In some examples, the transmitter 815 may be co-located with a receiver 810 in a transceiver component. The transmitter 815 may utilize a single antenna or a set of multiple antennas.

The device 805, or various components thereof, may be an example of means for performing various aspects of techniques for HARQ adaptation as described herein. For example, the communications manager 820 may include a deferral configuration component 825, a schedule component 830, a reevaluation component 835, an HARQ message component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The deferral configuration component 825 is capable of, configured to, or operable to support a means for receiving, from a network entity, an indication of a configuration of HARQ deferral for SPS. The schedule component 830 is capable of, configured to, or operable to support a means for receiving, from the network entity, a first downlink signal in accordance with the SPS, where a first schedule of a HARQ message associated with the first downlink signal is based on the configuration of HARQ deferral and a second schedule of a second downlink signal. The schedule component 830 is capable of, configured to, or operable to support a means for receiving, from the network entity, a message for changing the second schedule of the second downlink signal. The reevaluation component 835 is capable of, configured to, or operable to support a means for performing a reevaluation of the first schedule based on the message for changing the second schedule. The HARQ message component 840 is capable of, configured to, or operable to support a means for transmitting, to the network entity, the HARQ message based on the reevaluation of the first schedule.

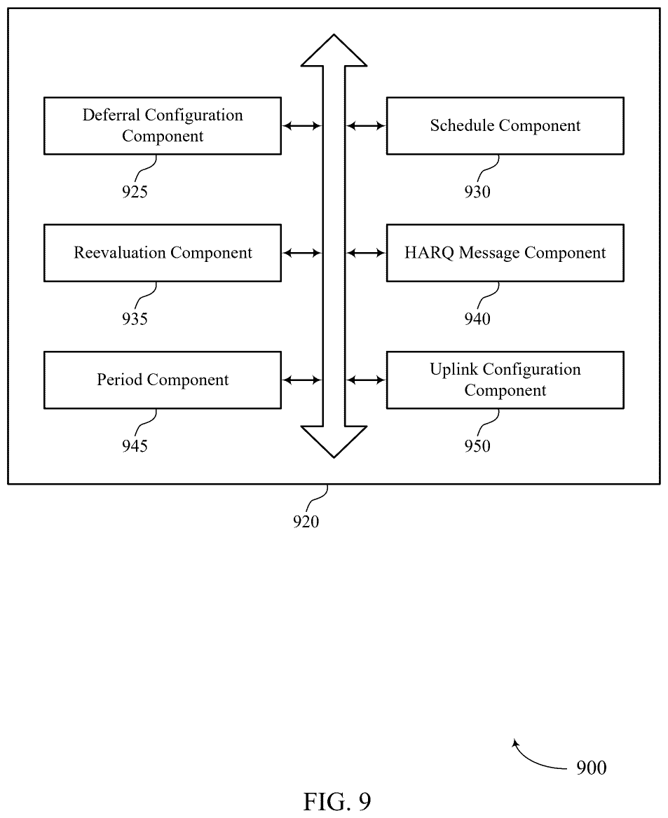

FIG. 9 shows a block diagram 900 of a communications manager 920 that supports techniques for HARQ adaptation in accordance with one or more aspects of the present disclosure. The communications manager 920 may be an example of aspects of a communications manager 720 (as shown in FIG. 7), a communications manager 820 (as shown in FIG. 8), or both, as described herein. The communications manager 920, or various components thereof, may be an example of means for performing various aspects of techniques for HARQ adaptation as described herein. For example, the communications manager 920 may include a deferral configuration component 925, a schedule component 930, a reevaluation component 935, an HARQ message component 940, a period component 945, an uplink configuration component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The deferral configuration component 925 is capable of, configured to, or operable to support a means for receiving, from a network entity, an indication of a configuration of HARQ deferral for SPS. The schedule component 930 is capable of, configured to, or operable to support a means for receiving, from the network entity, a first downlink signal in accordance with the SPS, where a first schedule of a HARQ message associated with the first downlink signal is based on the configuration of HARQ deferral and a second schedule of a second downlink signal. In some examples, the schedule component 930 is capable of, configured to, or operable to support a means for receiving, from the network entity, a message for changing the second schedule of the second downlink signal. The reevaluation component 935 is capable of, configured to, or operable to support a means for performing a reevaluation of the first schedule based on the message for changing the second schedule. The HARQ message component 940 is capable of, configured to, or operable to support a means for transmitting, to the network entity, the HARQ message based on the reevaluation of the first schedule.

In some examples, to support transmitting the HARQ message, the HARQ message component 940 is capable of, configured to, or operable to support a means for transmitting, to the network entity, the HARQ message in accordance with the first schedule, where the HARQ message is deferred based on the second schedule, and the first schedule is unchanged based on the message for changing the second schedule.

In some examples, to support transmitting the HARQ message, the HARQ message component 940 is capable of, configured to, or operable to support a means for transmitting, to the network entity, the HARQ message via a resource previously allocated to the second downlink signal in accordance with the second schedule, where the HARQ message was previously deferred based on the second schedule, and the first schedule is changed based on the message for changing the second schedule.

In some examples, the HARQ message is transmitted via the resource based on the message for changing the second schedule being received at least a threshold quantity of symbols before the HARQ message is transmitted via the resource.

In some examples, to support transmitting the HARQ message, the HARQ message component 940 is capable of, configured to, or operable to support a means for transmitting, to the network entity, the HARQ message via a second resource after a first resource allocated to the second downlink signal in accordance with the second schedule, where the HARQ message is deferred based on the second schedule, and the first schedule is changed based on the message for changing the second schedule.

In some examples, the HARQ message is deferred based on the first resource being allocated for a synchronization signal block (SSB), semi-static downlink symbols, or a CORESET for a type 0 PDCCH CSS.

In some examples, to support transmitting the HARQ message, the HARQ message component 940 is capable of, configured to, or operable to support a means for transmitting, to the network entity, the HARQ message via a resource allocated to the second downlink signal in accordance with the second schedule, where the first schedule is unchanged based on the message for changing the second schedule.

In some examples, the HARQ message is transmitted via the resource based on the message for changing the second schedule being received less than a threshold quantity of symbols before the HARQ message is transmitted via the resource.

In some examples, the HARQ message is transmitted via the resource concurrently with receiving the second downlink signal via the resource.

In some examples, the period component 945 is capable of, configured to, or operable to support a means for receiving a first indication of a threshold period for deferral associated with the configuration of HARQ deferral. In some examples, the period component 945 is capable of, configured to, or operable to support a means for receiving a second indication for changing the threshold period for deferral associated with the message for changing the second schedule of the second downlink signal.

In some examples, the uplink configuration component 950 is capable of, configured to, or operable to support a means for receiving, from the network entity, an indication of a set of configurations for a PUCCH. In some examples, the uplink configuration component 950 is capable of, configured to, or operable to support a means for switching from a first configuration to a second configuration of the set of configurations in association with (e.g., based on) the message for changing the second schedule.

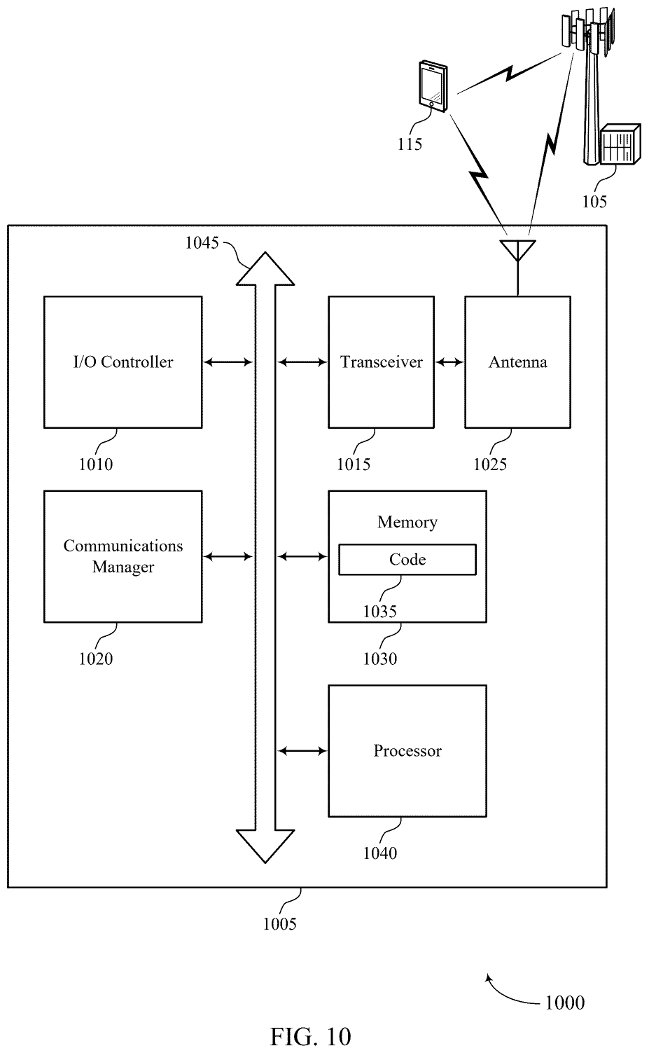

FIG. 10 shows a diagram of a system 1000 including a device 1005 that supports techniques for HARQ adaptation in accordance with one or more aspects of the present disclosure. The device 1005 may be an example of or include components of a device 705 (as shown in FIG. 7), a device 805 (as shown in FIG. 8), or a UE 115 (as shown in FIG. 1). The device 1005 may communicate (e.g., wirelessly) with one or more other devices (e.g., network entities 105 (as shown in FIG. 1), UEs 115 (as shown in FIG. 1), or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for HARQ adaptation). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving, from a network entity, an indication of a configuration of HARQ deferral for SPS. The communications manager 1020 is capable of, configured to, or operable to support a means for receiving, from the network entity, a first downlink signal in accordance with the SPS, where a first schedule of a HARQ message associated with the first downlink signal is based on the configuration of HARQ deferral and a second schedule of a second downlink signal. The communications manager 1020 is capable of, configured to, or operable to support a means for receiving, from the network entity, a message for changing the second schedule of the second downlink signal. The communications manager 1020 is capable of, configured to, or operable to support a means for performing a reevaluation of the first schedule based on the message for changing the second schedule. The communications manager 1020 is capable of, configured to, or operable to support a means for transmitting, to the network entity, the HARQ message based on the reevaluation of the first schedule.

By including or configuring the communications manager 1020 in accordance with examples as described herein, the device 1005 may support techniques for improved communication reliability, reduced latency, reduced power consumption, more efficient utilization of communication resources, improved coordination between devices, longer battery life, or improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for HARQ adaptation as described herein, or the at least one processor 1040 and the at least one memory 1030 may be otherwise configured to, individually or collectively, perform or support such operations.

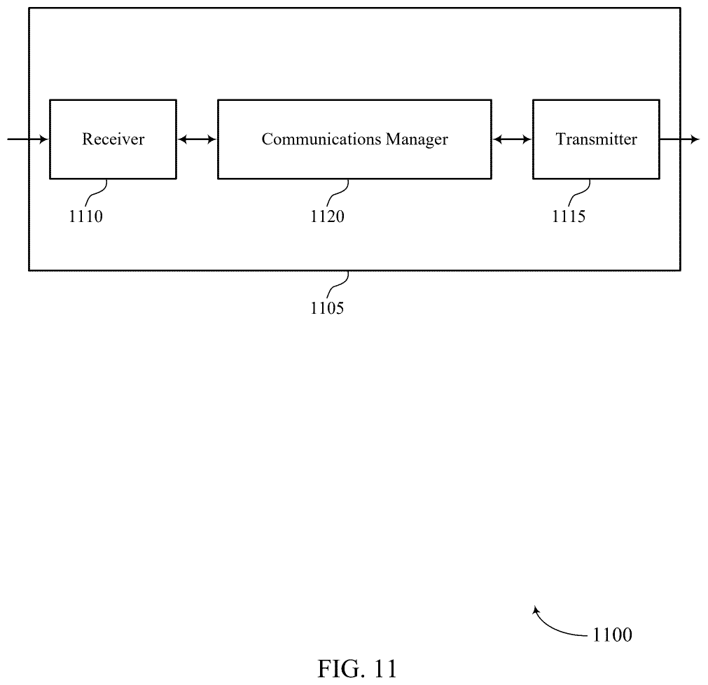

FIG. 11 shows a block diagram 1100 of a device 1105 that supports techniques for HARQ adaptation in accordance with one or more aspects of the present disclosure. The device 1105 may be an example of aspects of a network entity 105 (as shown in FIG. 1). The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for HARQ adaptation as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting, to a UE, an indication of a configuration of HARQ deferral for SPS. The communications manager 1120 is capable of, configured to, or operable to support a means for outputting, to the UE, a first downlink signal in accordance with the SPS, where a first schedule of a HARQ message associated with the first downlink signal is based on the configuration of HARQ deferral and a second schedule of a second downlink signal. The communications manager 1120 is capable of, configured to, or operable to support a means for outputting, to the UE, a message for changing the second schedule of the second downlink signal. The communications manager 1120 is capable of, configured to, or operable to support a means for performing a reevaluation of the first schedule based on changing the second schedule. The communications manager 1120 is capable of, configured to, or operable to support a means for obtaining, from the UE, the HARQ message based on the reevaluation of the first schedule.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, or more efficient utilization of communication resources.

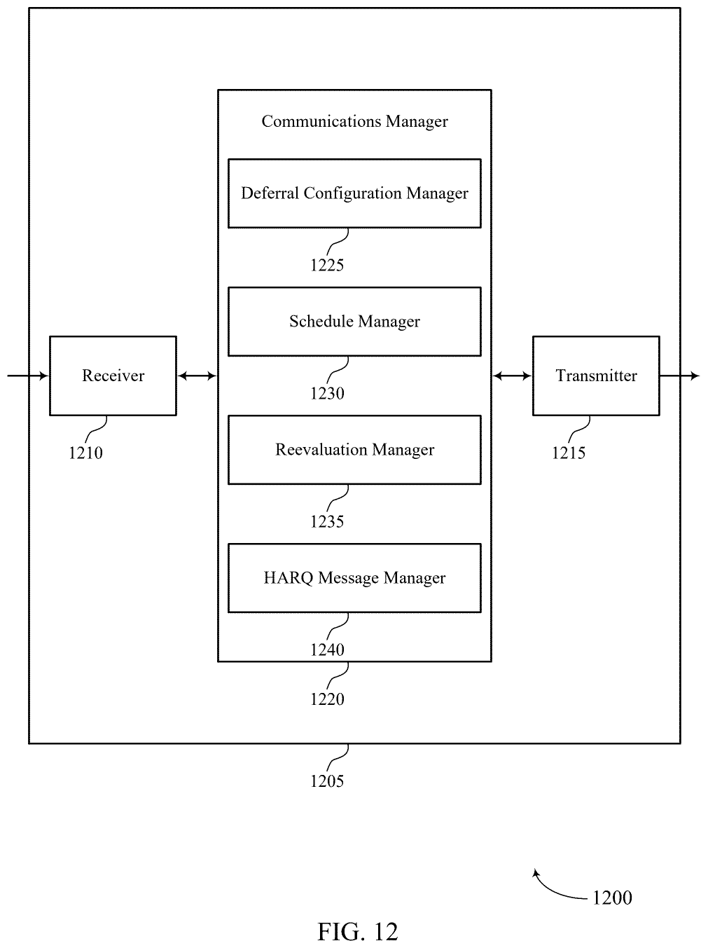

FIG. 12 shows a block diagram 1200 of a device 1205 that supports techniques for HARQ adaptation in accordance with one or more aspects of the present disclosure. The device 1205 may be an example of aspects of a device 1105 (as shown in FIG. 11) or a network entity 105 (as shown in FIG. 1). The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for HARQ adaptation as described herein. For example, the communications manager 1220 may include a deferral configuration manager 1225, a schedule manager 1230, a reevaluation manager 1235, an HARQ message manager 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The deferral configuration manager 1225 is capable of, configured to, or operable to support a means for outputting, to a UE, an indication of a configuration of HARQ deferral for SPS. The schedule manager 1230 is capable of, configured to, or operable to support a means for outputting, to the UE, a first downlink signal in accordance with the SPS, where a first schedule of a HARQ message associated with the first downlink signal is based on the configuration of HARQ deferral and a second schedule of a second downlink signal. The schedule manager 1230 is capable of, configured to, or operable to support a means for outputting, to the UE, a message for changing the second schedule of the second downlink signal. The reevaluation manager 1235 is capable of, configured to, or operable to support a means for performing a reevaluation of the first schedule based on changing the second schedule. The HARQ message manager 1240 is capable of, configured to, or operable to support a means for obtaining, from the UE, the HARQ message based on the reevaluation of the first schedule.

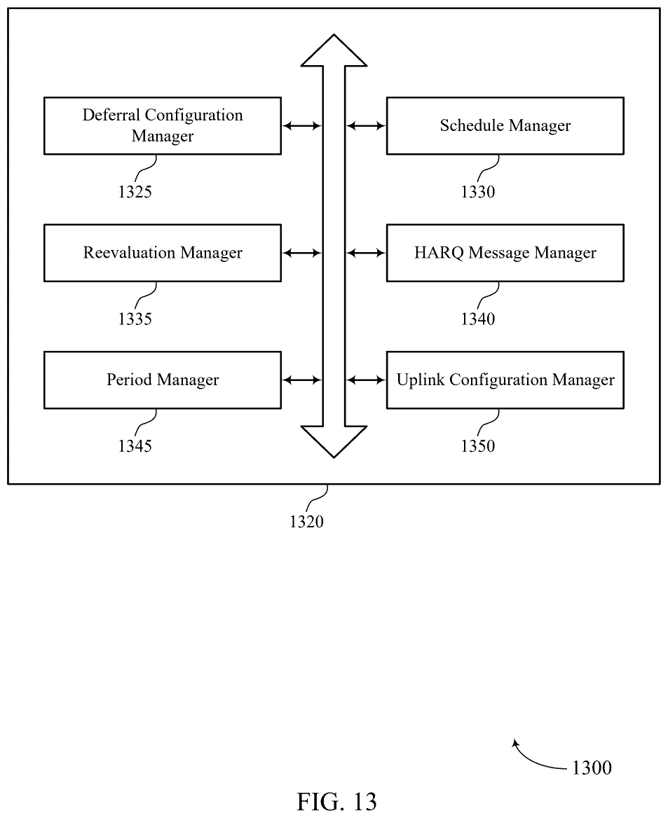

FIG. 13 shows a block diagram 1300 of a communications manager 1320 that supports techniques for HARQ adaptation in accordance with one or more aspects of the present disclosure. The communications manager 1320 may be an example of aspects of a communications manager 1120 (as shown in FIG. 11), a communications manager 1220 (as shown in FIG. 12), or both, as described herein. The communications manager 1320, or various components thereof, may be an example of means for performing various aspects of techniques for HARQ adaptation as described herein. For example, the communications manager 1320 may include a deferral configuration manager 1325, a schedule manager 1330, a reevaluation manager 1335, an HARQ message manager 1340, a period manager 1345, an uplink configuration manager 1350, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The deferral configuration manager 1325 is capable of, configured to, or operable to support a means for outputting, to a UE, an indication of a configuration of HARQ deferral for SPS. The schedule manager 1330 is capable of, configured to, or operable to support a means for outputting, to the UE, a first downlink signal in accordance with the SPS, where a first schedule of a HARQ message associated with the first downlink signal is based on the configuration of HARQ deferral and a second schedule of a second downlink signal. In some examples, the schedule manager 1330 is capable of, configured to, or operable to support a means for outputting, to the UE, a message for changing the second schedule of the second downlink signal. The reevaluation manager 1335 is capable of, configured to, or operable to support a means for performing a reevaluation of the first schedule based on changing the second schedule. The HARQ message manager 1340 is capable of, configured to, or operable to support a means for obtaining, from the UE, the HARQ message based on the reevaluation of the first schedule.

In some examples, to support obtaining the HARQ message, the HARQ message manager 1340 is capable of, configured to, or operable to support a means for obtaining, from the UE, the HARQ message in accordance with the first schedule, where the HARQ message is deferred based on the second schedule, and the first schedule is unchanged based on the message for changing the second schedule.

In some examples, to support obtaining the HARQ message, the HARQ message manager 1340 is capable of, configured to, or operable to support a means for obtaining, from the UE, the HARQ message via a resource previously allocated to the second downlink signal in accordance with the second schedule, where the HARQ message was previously deferred based on the second schedule, and the first schedule is changed based on the message for changing the second schedule.

In some examples, the HARQ message is transmitted via the resource based on the message for changing the second schedule being received at least a threshold quantity of symbols before the HARQ message is transmitted via the resource.

In some examples, to support obtaining the HARQ message, the HARQ message manager 1340 is capable of, configured to, or operable to support a means for obtaining, from the UE, the HARQ message via a second resource after a first resource allocated to the second downlink signal in accordance with the second schedule, where the HARQ message is deferred based on the second schedule, and the first schedule is changed based on the message for changing the second schedule.

In some examples, to support obtaining the HARQ message, the HARQ message manager 1340 is capable of, configured to, or operable to support a means for obtaining, from the UE, the HARQ message via a resource allocated to the second downlink signal in accordance with the second schedule, where the first schedule is unchanged based on the message for changing the second schedule.

In some examples, the period manager 1345 is capable of, configured to, or operable to support a means for outputting a first indication of a threshold period for deferral associated with the configuration of HARQ deferral. In some examples, the period manager 1345 is capable of, configured to, or operable to support a means for outputting a second indication for changing the threshold period for deferral associated with the message for changing the second schedule of the second downlink signal.

In some examples, the uplink configuration manager 1350 is capable of, configured to, or operable to support a means for outputting, to the UE, an indication of a set of configurations for a PUCCH. In some examples, the uplink configuration manager 1350 is capable of, configured to, or operable to support a means for switching from a first configuration to a second configuration of the set of configurations in association with (e.g., based on) the message for changing the second schedule.

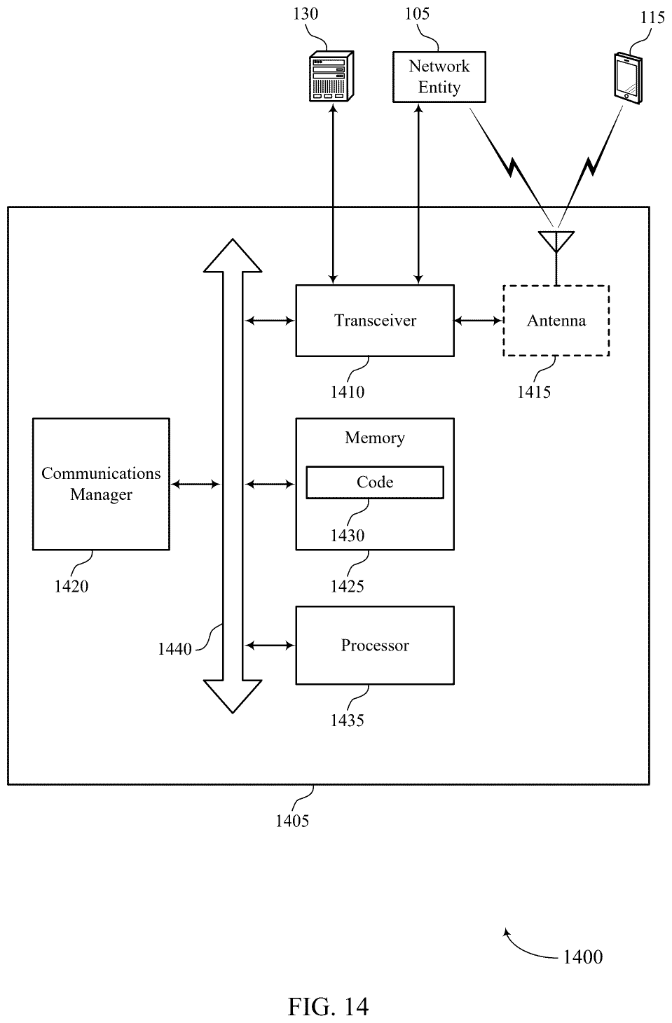

FIG. 14 shows a diagram of a system 1400 including a device 1405 that supports techniques for HARQ adaptation in accordance with one or more aspects of the present disclosure. The device 1405 may be an example of or include components of a device 1105 (as shown in FIG. 11), a device 1205 (as shown in FIG. 12), or a network entity 105 (as shown in FIG. 1) as described herein. The device 1405 may communicate with other network devices or network equipment such as one or more of the network entities 105 (as shown in FIG. 1), UEs 115 (as shown in FIG. 1), or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, or a fronthaul communication link 168 (as shown in FIG. 1)).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for HARQ adaptation). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting, to a UE, an indication of a configuration of HARQ deferral for SPS. The communications manager 1420 is capable of, configured to, or operable to support a means for outputting, to the UE, a first downlink signal in accordance with the SPS, where a first schedule of a HARQ message associated with the first downlink signal is based on the configuration of HARQ deferral and a second schedule of a second downlink signal. The communications manager 1420 is capable of, configured to, or operable to support a means for outputting, to the UE, a message for changing the second schedule of the second downlink signal. The communications manager 1420 is capable of, configured to, or operable to support a means for performing a reevaluation of the first schedule based on changing the second schedule. The communications manager 1420 is capable of, configured to, or operable to support a means for obtaining, from the UE, the HARQ message based on the reevaluation of the first schedule.

By including or configuring the communications manager 1420 in accordance with examples as described herein, the device 1405 may support techniques for improved communication reliability, reduced latency, reduced power consumption, more efficient utilization of communication resources, improved coordination between devices, longer battery life, or improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for HARQ adaptation as described herein, or the at least one processor 1435 and the at least one memory 1425 may be otherwise configured to, individually or collectively, perform or support such operations.

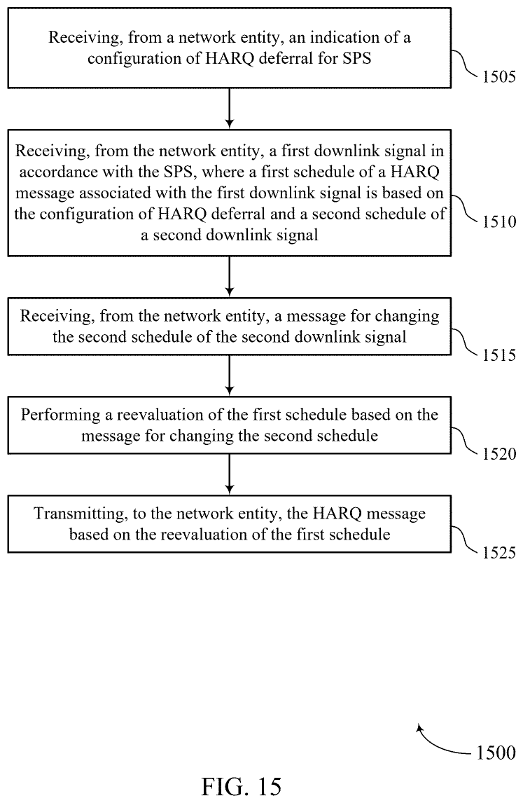

FIG. 15 shows a flowchart illustrating a method 1500 that supports techniques for HARQ adaptation in accordance with one or more aspects of the present disclosure. The operations of the method 1500 may be implemented by a UE or its components as described herein. For example, the operations of the method 1500 may be performed by a UE 115 (as shown in FIG. 1) as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, an indication of a configuration of HARQ deferral for SPS. The operations of 1505 may be performed in accordance with examples as disclosed herein. In some examples, aspects of the operations of 1505 may be performed by a deferral configuration component 925 as described with reference to FIG. 9.

At 1510, the method may include receiving, from the network entity, a first downlink signal in accordance with the SPS, where a first schedule of a HARQ message associated with the first downlink signal is based on the configuration of HARQ deferral and a second schedule of a second downlink signal. The operations of 1510 may be performed in accordance with examples as disclosed herein. In some examples, aspects of the operations of 1510 may be performed by a schedule component 930 as described with reference to FIG. 9.

At 1515, the method may include receiving, from the network entity, a message for changing the second schedule of the second downlink signal. The operations of 1515 may be performed in accordance with examples as disclosed herein. In some examples, aspects of the operations of 1515 may be performed by a schedule component 930 as described with reference to FIG. 9.

At 1520, the method may include performing a reevaluation of the first schedule based on the message for changing the second schedule. The operations of 1520 may be performed in accordance with examples as disclosed herein. In some examples, aspects of the operations of 1520 may be performed by a reevaluation component 935 as described with reference to FIG. 9.

At 1525, the method may include transmitting, to the network entity, the HARQ message based on the reevaluation of the first schedule. The operations of 1525 may be performed in accordance with examples as disclosed herein. In some examples, aspects of the operations of 1525 may be performed by an HARQ message component 940 as described with reference to FIG. 9.

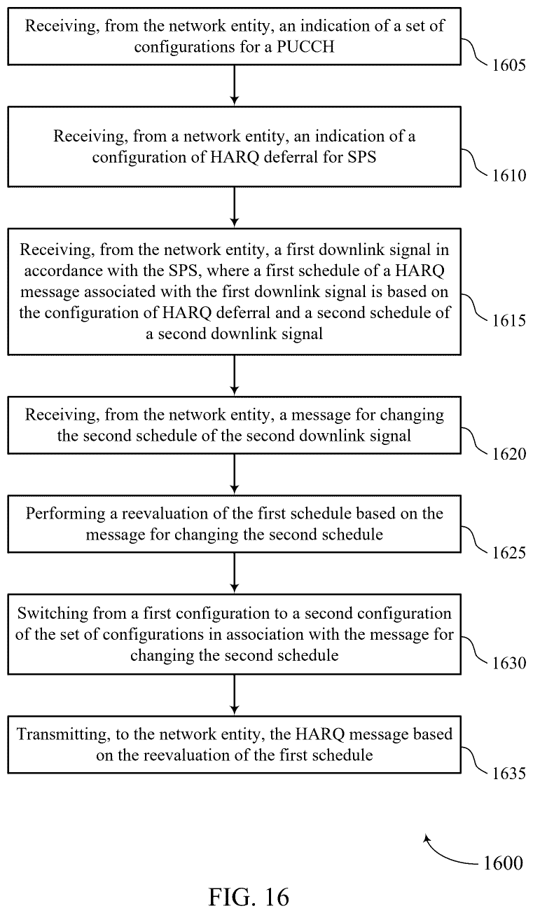

FIG. 16 shows a flowchart illustrating a method 1600 that supports techniques for HARQ adaptation in accordance with one or more aspects of the present disclosure. The operations of the method 1600 may be implemented by a UE or its components as described herein. For example, the operations of the method 1600 may be performed by a UE 115 (as shown in FIG. 1) as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from the network entity, an indication of a set of configurations for a PUCCH. The operations of 1605 may be performed in accordance with examples as disclosed herein. In some examples, aspects of the operations of 1605 may be performed by an uplink configuration component 950 as described with reference to FIG. 9.

At 1610, the method may include receiving, from a network entity, an indication of a configuration of HARQ deferral for SPS. The operations of 1610 may be performed in accordance with examples as disclosed herein. In some examples, aspects of the operations of 1610 may be performed by a deferral configuration component 925 as described with reference to FIG. 9.

At 1615, the method may include receiving, from the network entity, a first downlink signal in accordance with the SPS, where a first schedule of a HARQ message associated with the first downlink signal is based on the configuration of HARQ deferral and a second schedule of a second downlink signal. The operations of 1615 may be performed in accordance with examples as disclosed herein. In some examples, aspects of the operations of 1615 may be performed by a schedule component 930 as described with reference to FIG. 9.

At 1620, the method may include receiving, from the network entity, a message for changing the second schedule of the second downlink signal. The operations of 1620 may be performed in accordance with examples as disclosed herein. In some examples, aspects of the operations of 1620 may be performed by a schedule component 930 as described with reference to FIG. 9.

At 1625, the method may include performing a reevaluation of the first schedule based on the message for changing the second schedule. The operations of 1625 may be performed in accordance with examples as disclosed herein. In some examples, aspects of the operations of 1625 may be performed by a reevaluation component 935 as described with reference to FIG. 9.

At 1630, the method may include switching from a first configuration to a second configuration of the set of configurations in association with (e.g., based on) the message for changing the second schedule. The operations of 1630 may be performed in accordance with examples as disclosed herein. In some examples, aspects of the operations of 1630 may be performed by an uplink configuration component 950 as described with reference to FIG. 9.

At 1635, the method may include transmitting, to the network entity, the HARQ message based on the reevaluation of the first schedule. The operations of 1635 may be performed in accordance with examples as disclosed herein. In some examples, aspects of the operations of 1635 may be performed by an HARQ message component 940 as described with reference to FIG. 9.

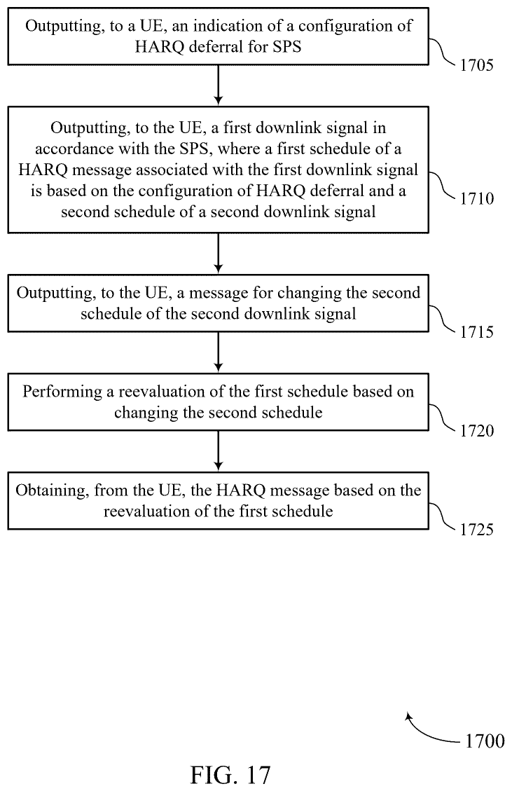

FIG. 17 shows a flowchart illustrating a method 1700 that supports

techniques for HARQ adaptation in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a UE, an indication of a configuration of HARQ deferral for SPS. The operations of 1705 may be performed in accordance with examples as disclosed herein. In some examples, aspects of the operations of 1705 may be performed by a deferral configuration manager 1325 as described with reference to FIG. 13.

At 1710, the method may include outputting, to the UE, a first downlink signal in accordance with the SPS, where a first schedule of a HARQ message associated with the first downlink signal is based on the configuration of HARQ deferral and a second schedule of a second downlink signal. The operations of 1710 may be performed in accordance with examples as disclosed herein. In some examples, aspects of the operations of 1710 may be performed by a schedule manager 1330 as described with reference to FIG. 13.

At 1715, the method may include outputting, to the UE, a message for changing the second schedule of the second downlink signal. The operations of 1715 may be performed in accordance with examples as disclosed herein. In some examples, aspects of the operations of 1715 may be performed by a schedule manager 1330 as described with reference to FIG. 13.

At 1720, the method may include performing a reevaluation of the first schedule based on changing the second schedule. The operations of 1720 may be performed in accordance with examples as disclosed herein. In some examples, aspects of the operations of 1720 may be performed by a reevaluation manager 1335 as described with reference to FIG. 13.

At 1725, the method may include obtaining, from the UE, the HARQ message based on the reevaluation of the first schedule. The operations of 1725 may be performed in accordance with examples as disclosed herein. In some examples, aspects of the operations of 1725 may be performed by an HARQ message manager 1340 as described with reference to FIG. 13.

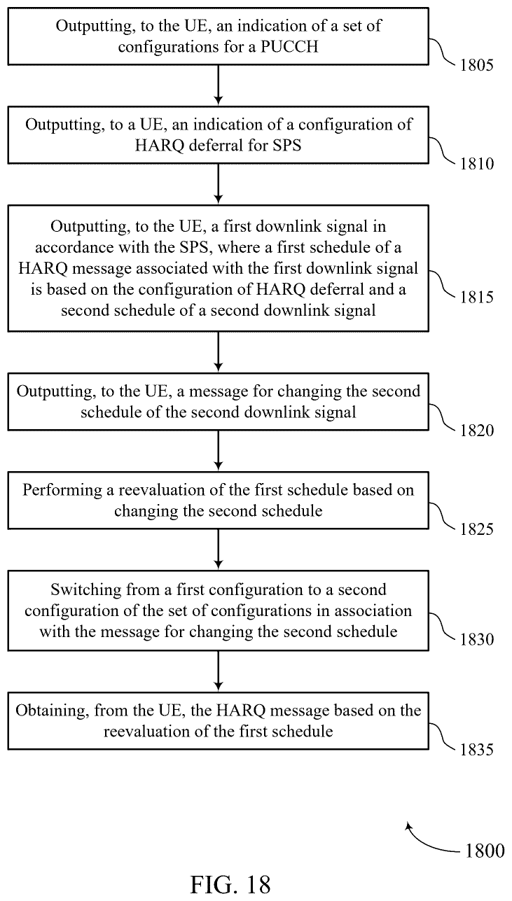

FIG. 18 shows a flowchart illustrating a method 1800 that supports techniques for HARQ adaptation in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting, to the UE, an indication of a set of configurations for a PUCCH. The operations of 1805 may be performed in accordance with examples as disclosed herein. In some examples, aspects of the operations of 1805 may be performed by an uplink configuration manager 1350 as described with reference to FIG. 13.

At 1810, the method may include outputting, to a UE, an indication of a configuration of HARQ deferral for SPS. The operations of 1810 may be performed in accordance with examples as disclosed herein. In some examples, aspects of the operations of 1810 may be performed by a deferral configuration manager 1325 as described with reference to FIG. 13.

At 1815, the method may include outputting, to the UE, a first downlink signal in accordance with the SPS, where a first schedule of a HARQ message associated with the first downlink signal is based on the configuration of HARQ deferral and a second schedule of a second downlink signal. The operations of 1815 may be performed in accordance with examples as disclosed herein. In some examples, aspects of the operations of 1815 may be performed by a schedule manager 1330 as described with reference to FIG. 13.

At 1820, the method may include outputting, to the UE, a message for changing the second schedule of the second downlink signal. The operations of 1820 may be performed in accordance with examples as disclosed herein. In some examples, aspects of the operations of 1820 may be performed by a schedule manager 1330 as described with reference to FIG. 13.

At 1825, the method may include performing a reevaluation of the first schedule based on changing the second schedule. The operations of 1825 may be performed in accordance with examples as disclosed herein. In some examples, aspects of the operations of 1825 may be performed by a reevaluation manager 1335 as described with reference to FIG. 13.

At 1830, the method may include switching from a first configuration to a second configuration of the set of configurations in association with (e.g., based on) the message for changing the second schedule. The operations of 1830 may be performed in accordance with examples as disclosed herein. In some examples, aspects of the operations of 1830 may be performed by an uplink configuration manager 1350 as described with reference to FIG. 13.

At 1835, the method may include obtaining, from the UE, the HARQ message based on the reevaluation of the first schedule. The operations of 1835 may be performed in accordance with examples as disclosed herein. In some examples, aspects of the operations of 1835 may be performed by an HARQ message manager 1340 as described with reference to FIG. 13.

The following provides an overview of aspects of the present disclosure:

Aspect 1: A method for wireless communications at a UE, comprising: receiving, from a network entity, an indication of a configuration of HARQ deferral for SPS; receiving, from the network entity, a first downlink signal in accordance with the SPS, wherein a first schedule of a HARQ message associated with the first downlink signal is based at least in part on the configuration of HARQ deferral and a second schedule of a second downlink signal; receiving, from the network entity, a message for changing the second schedule of the second downlink signal; performing a reevaluation of the first schedule based at least in part on the message for changing the second schedule; and transmitting, to the network entity, the HARQ message based at least in part on the reevaluation of the first schedule.

Aspect 2: The method of aspect 1, wherein transmitting the HARQ message comprises: transmitting, to the network entity, the HARQ message in accordance with the first schedule, wherein the HARQ message is deferred based at least in part on the second schedule, and the first schedule is unchanged based at least in part on the message for changing the second schedule.

Aspect 3: The method of aspect 1, wherein transmitting the HARQ message comprises: transmitting, to the network entity, the HARQ message via a resource previously allocated to the second downlink signal in accordance with the second schedule, wherein the HARQ message was previously deferred based at least in part on the second schedule, and the first schedule is changed based at least in part on the message for changing the second schedule.

Aspect 4: The method of aspect 3, wherein the HARQ message is transmitted via the resource based at least in part on the message for changing the second schedule being received at least a threshold quantity of symbols before the HARQ message is transmitted via the resource.

Aspect 5: The method of aspect 1, wherein transmitting the HARQ message comprises: transmitting, to the network entity, the HARQ message via a second resource after a first resource allocated to the second downlink signal in accordance with the second schedule, wherein the HARQ message is deferred based at least in part on the second schedule, and the first schedule is changed based at least in part on the message for changing the second schedule.

Aspect 6: The method of aspect 5, wherein the HARQ message is deferred based at least in part on the first resource being allocated for a SSB, semi-static downlink symbols, or a CORESET for a type 0 PDCCH CSS.

Aspect 7: The method of any of aspect 1, wherein transmitting the HARQ message comprises: transmitting, to the network entity, the HARQ message via a resource allocated to the second downlink signal in accordance with the second schedule, wherein the first schedule is unchanged based at least in part on the message for changing the second schedule.

Aspect 8: The method of aspect 7, wherein the HARQ message is transmitted via the resource based at least in part on the message for changing the second schedule being received less than a threshold quantity of symbols before the HARQ message is transmitted via the resource.

Aspect 9: The method of any of aspects 7 through 8, wherein the HARQ message is transmitted via the resource concurrently with receiving the second downlink signal via the resource.

Aspect 10: The method of any of aspects 1 through 9, further comprising: receiving a first indication of a threshold period for deferral associated with the configuration of HARQ deferral; and receiving a second indication for changing the threshold period for deferral associated with the message for changing the second schedule of the second downlink signal.

Aspect 11: The method of any of aspects 1 through 10, further comprising: receiving, from the network entity, an indication of a set of configurations for a PUCCH; and switching from a first configuration to a second configuration of the set of configurations in association with the message for changing the second schedule.

Aspect 12: A method for wireless communications at a network entity, comprising: outputting, to a UE, an indication of a configuration of HARQ deferral for SPS; outputting, to the UE, a first downlink signal in accordance with the SPS, wherein a first schedule of a HARQ message associated with the first downlink signal is based at least in part on the configuration of HARQ deferral and a second schedule of a second downlink signal; outputting, to the UE, a message for changing the second schedule of the second downlink signal; performing a reevaluation of the first schedule based at least in part on changing the second schedule; and obtaining, from the UE, the HARQ message based at least in part on the reevaluation of the first schedule.

Aspect 13: The method of aspect 12, wherein obtaining the HARQ message comprises: obtaining, from the UE, the HARQ message in accordance with the first schedule, wherein the HARQ message is deferred based at least in part on the second schedule, and the first schedule is unchanged based at least in part on the message for changing the second schedule.

Aspect 14: The method of aspect 12, wherein obtaining the HARQ message comprises: obtaining, from the UE, the HARQ message via a resource previously allocated to the second downlink signal in accordance with the second schedule, wherein the HARQ message was previously deferred based at least in part on the second schedule, and the first schedule is changed based at least in part on the message for changing the second schedule.

Aspect 15: The method of aspect 14, wherein the HARQ message is transmitted via the resource based at least in part on the message for changing the second schedule being received at least a threshold quantity of symbols before the HARQ message is transmitted via the resource.

Aspect 16: The method of aspect 12, wherein obtaining the HARQ message comprises: obtaining, from the UE, the HARQ message via a second resource after a first resource allocated to the second downlink signal in accordance with the second schedule, wherein the HARQ message is deferred based at least in part on the second schedule, and the first schedule is changed based at least in part on the message for changing the second schedule.

Aspect 17: The method of aspect 12, wherein obtaining the HARQ message comprises: obtaining, from the UE, the HARQ message via a resource allocated to the second downlink signal in accordance with the second schedule, wherein the first schedule is unchanged based at least in part on the message for changing the second schedule.

Aspect 18: The method of any of aspects 12 through 17, further comprising: outputting a first indication of a threshold period for deferral associated with the configuration of HARQ deferral; and outputting a second indication for changing the threshold period for deferral associated with the message for changing the second schedule of the second downlink signal.

Aspect 19: The method of any of aspects 12 through 18, further comprising: outputting, to the UE, an indication of a set of configurations for a PUCCH; and switching from a first configuration to a second configuration of the set of configurations in association with the message for changing the second schedule.

Aspect 20: A UE for wireless communications, comprising one or more memories storing processor-executable code, and one or more processors coupled with the one or more memories and individually or collectively operable to execute the code to cause the UE to perform a method of any of aspects 1 through 11.

Aspect 21: A UE for wireless communications, comprising at least one means for performing a method of any of aspects 1 through 11.

Aspect 22: A non-transitory computer-readable medium storing code for wireless communications, the code comprising instructions executable by one or more processors to perform a method of any of aspects 1 through 11.

Aspect 23: A network entity for wireless communications, comprising one or more memories storing processor-executable code, and one or more processors coupled with the one or more memories and individually or collectively operable to execute the code to cause the network entity to perform a method of any of aspects 12 through 19.

Aspect 24: A network entity for wireless communications, comprising at least one means for performing a method of any of aspects 12 through 19.

Aspect 25: A non-transitory computer-readable medium storing code for wireless communications, the code comprising instructions executable by one or more processors to perform a method of any of aspects 12 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a characteristic or performing a function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a network entity, an indication of a configuration of hybrid automatic repeat request (HARQ) deferral for semi-persistent scheduling (SPS);
receiving, from the network entity, a first downlink signal in accordance with the SPS, wherein a first schedule of a HARQ message associated with the first downlink signal is based at least in part on the configuration of HARQ deferral and a second schedule of a second downlink signal;
receiving, from the network entity, a message for changing the second schedule of the second downlink signal;
performing a reevaluation of the first schedule based at least in part on the message for changing the second schedule; and
transmitting, to the network entity, the HARQ message based at least in part on the reevaluation of the first schedule.

2. The method of claim 1, wherein transmitting the HARQ message comprises:
transmitting, to the network entity, the HARQ message in accordance with the first schedule, wherein the HARQ message is deferred based at least in part on the second schedule, and the first schedule is unchanged based at least in part on the message for changing the second schedule.

3. The method of claim 1, wherein transmitting the HARQ message comprises:
transmitting, to the network entity, the HARQ message via a resource previously allocated to the second downlink signal in accordance with the second schedule, wherein the HARQ message was previously deferred based at least in part on the second schedule, and the first schedule is changed based at least in part on the message for changing the second schedule.

4. The method of claim 3, wherein the HARQ message is transmitted via the resource based at least in part on the message for changing the second schedule being received at least a threshold quantity of symbols before the HARQ message is transmitted via the resource.

5. The method of claim 1, wherein transmitting the HARQ message comprises:
transmitting, to the network entity, the HARQ message via a second resource after a first resource allocated to the second downlink signal in accordance with the second schedule, wherein the HARQ message is deferred based at least in part on the second schedule, and the first schedule is changed based at least in part on the message for changing the second schedule.

6. The method of claim 5, wherein the HARQ message is deferred based at least in part on the first resource being allocated for a synchronization signal block (SSB), semi-static downlink symbols, or a control resource set (CORESET) for a type 0 physical downlink control channel (PDCCH) common search space (CSS).

7. The method of claim 1, wherein transmitting the HARQ message comprises:
transmitting, to the network entity, the HARQ message via a resource allocated to the second downlink signal in accordance with the second schedule, wherein the first schedule is unchanged based at least in part on the message for changing the second schedule.

8. The method of claim 7, wherein the HARQ message is transmitted via the resource based at least in part on the message for changing the second schedule being received less than a threshold quantity of symbols before the HARQ message is transmitted via the resource.

9. The method of claim 7, wherein the HARQ message is transmitted via the resource concurrently with receiving the second downlink signal via the resource.

10. The method of claim 1, further comprising:
receiving a first indication of a threshold period for deferral associated with the configuration of HARQ deferral; and
receiving a second indication for changing the threshold period for deferral associated with the message for changing the second schedule of the second downlink signal.

11. The method of claim 1, further comprising:
receiving, from the network entity, an indication of a set of configurations for a physical uplink control channel (PUCCH); and
switching from a first configuration to a second configuration of the set of configurations in association with the message for changing the second schedule.

12. A method for wireless communications at a network entity, comprising:
outputting, to a user equipment (UE), an indication of a configuration of hybrid automatic repeat request (HARQ) deferral for semi-persistent scheduling (SPS);
outputting, to the UE, a first downlink signal in accordance with the SPS, wherein a first schedule of a HARQ message associated with the first downlink signal is based at least in part on the configuration of HARQ deferral and a second schedule of a second downlink signal;
outputting, to the UE, a message for changing the second schedule of the second downlink signal;
performing a reevaluation of the first schedule based at least in part on changing the second schedule; and
obtaining, from the UE, the HARQ message based at least in part on the reevaluation of the first schedule.

13. The method of claim 12, wherein obtaining the HARQ message comprises:
obtaining, from the UE, the HARQ message in accordance with the first schedule, wherein the HARQ message is deferred based at least in part on the second schedule, and the first schedule is unchanged based at least in part on the message for changing the second schedule.

14. The method of claim 12, wherein obtaining the HARQ message comprises:
obtaining, from the UE, the HARQ message via a resource previously allocated to the second downlink signal in accordance with the second schedule, wherein the HARQ message was previously deferred based at least in part on the second schedule, and the first schedule is changed based at least in part on the message for changing the second schedule.

15. The method of claim 14, wherein the HARQ message is transmitted via the resource based at least in part on the message for changing the second schedule being received at least a threshold quantity of symbols before the HARQ message is transmitted via the resource.

16. The method of claim 12, wherein obtaining the HARQ message comprises:
obtaining, from the UE, the HARQ message via a second resource after a first resource allocated to the second downlink signal in accordance with the second schedule, wherein the HARQ message is deferred based at least in part on the second schedule, and the first schedule is changed based at least in part on the message for changing the second schedule.

17. The method of claim 12, wherein obtaining the HARQ message comprises:
obtaining, from the UE, the HARQ message via a resource allocated to the second downlink signal in accordance with the second schedule, wherein the first schedule is unchanged based at least in part on the message for changing the second schedule.

18. The method of claim 12, further comprising:
receiving a first indication of a threshold period for deferral associated with the configuration of HARQ deferral; and
receiving a second indication for changing the threshold period for deferral associated with the message for changing the second schedule of the second downlink signal.

19. The method of claim 12, further comprising:
receiving, from the network entity, an indication of a set of configurations for a physical uplink control channel (PUCCH); and
switching from a first configuration to a second configuration of the set of configurations in association with the message for changing the second schedule.

20. A user equipment (UE), comprising:
one or more memories storing processor-executable code; and
one or more processors coupled with the one or more memories and individually or collectively operable to execute the code to cause the UE to:
receive, from a network entity, an indication of a configuration of hybrid automatic repeat request (HARQ) deferral for semi-persistent scheduling (SPS);
receive, from the network entity, a first downlink signal in accordance with the SPS, wherein a first schedule of a HARQ message associated with the first downlink signal is based at least in part on the configuration of HARQ deferral and a second schedule of a second downlink signal;
receive, from the network entity, a message for changing the second schedule of the second downlink signal;
perform a reevaluation of the first schedule based at least in part on the message for changing the second schedule; and
transmit, to the network entity, the HARQ message based at least in part on the reevaluation of the first schedule.
